(19) United States
(12) Patent Application Publication
(10) Pub. No.: US 2024/0298271 A1
(43) Pub. Date: Sep. 5, 2024

(54) POWER HEADROOM REPORTING FOR PUSCH TRANSMISSIONS TOWARDS MULTIPLE TRPs

(71) Applicant: Telefonaktiebolaget LM Ericsson (publ), Stockholm (SE)

(72) Inventors: Shiwei Gao, Nepean (CA); Siva Muruganathan, Stittsville (CA); Helka-Liina Määttänen, Espoo (FI); Ravikiran Nory, San Jose, CA (US)

(21) Appl. No.: 18/559,592

(22) PCT Filed: May 11, 2022
(86) PCT No.: PCT/IB2022/054403

§ 371 Date: Nov. 8, 2023

Related U.S. Application Data
(60) Provisional application No. 63/187,141, filed on May 11, 2021.

(51) Int. Cl. H04W 52/36; H04L 5/00; H04W 72/23

(52) U.S. Cl. CPC H04W 52/365; H04L 5/0048; H04W 72/23

(57) ABSTRACT

Systems and methods for power headroom reporting for uplink transmissions towards multiple Transmission and Reception Points (TRPs) are disclosed. In one embodiment, a method performed by a wireless communication device comprises receiving, from a base station, downlink control information or a configuration that schedules an uplink transmission with two or more repetitions, wherein each of the two or more repetitions is associated to a different one of two or more Sounding Reference Signal (SRS) resource sets and a different one of two or more power headrooms (PHs) and a power headroom report (PHR) is triggered and is to be carried by the uplink transmission. The method further comprises calculating at least one PH among the two or more PHs, constructing a PHR Medium Access Control (MAC) Control Element (CE) comprising the at least one PH, and transmitting the PHR MAC CE in the uplink transmission.

### RELATED APPLICATIONS

This application claims the benefit of provisional patent application Ser. No. 63/187,141, filed May 11, 2021, the disclosure of which is hereby incorporated herein by reference in its entirety.

### TECHNICAL FIELD

The present disclosure relates to uplink power control in a cellular communications system and, more specifically, to power headroom reporting for uplink transmission in a cellular communications system.

### BACKGROUND

The next generation mobile wireless communication system (i.e., the Fifth Generation (5G) system) or new radio (NR) will support a diverse set of use cases and a diverse set of deployment scenarios. The later includes deployment at both low frequencies (below 6 Gigahertz (GHZ)) and very high frequencies (up to 10's of GHZ).

### NR Frame Structure and Resource Grid

Third Generation Partnership Project (3GPP) NR uses Cyclic Prefix Orthogonal Frequency Division Multiplexing (CP-OFDM) in both downlink (DL) (i.e., from a network node, gNB, or base station, to a user equipment or UE) and uplink (UL) (i.e., from UE to gNB). Discrete Fourier Transform (DFT) spread Orthogonal Frequency Division Multiplexing (OFDM) is also supported in the uplink. In the time domain, NR downlink and uplink are organized into equally sized subframes of 1 millisecond (ms) each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is shown in FIG. 1 with a 14-symbol slot, where the first two symbols contain Physical Downlink Control Channel (PDCCH) and the rest contains physical shared data channel, either Physical Downlink Shared Channel (PDSCH) or Physical Uplink Shared Channel (PUSCH).

Different subcarrier spacing values are supported in NR. The supported subcarrier spacing values (also referred to as different numerologies) are given by Δf=(15×2^{μ}) kilohertz (kHz) where μ∈{0, 1, 2, 3, 4}. Δf=15 kHz is the basic subcarrier spacing. The slot durations at different subcarrier spacings is given by ½^{μ} ms.

In the frequency domain, a system bandwidth is divided into resource blocks (RBs), each corresponding to twelve contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

DL PDSCH transmissions can be either dynamically scheduled, i.e., in each slot the gNB transmits Downlink Control Information (DCI) over Physical Downlink Control Channel (PDCCH) about which UE data is to be transmitted to and which RBs in the current downlink slot the data is transmitted on, or semi-persistently scheduled (SPS) in which periodic PDSCH transmissions are activated or deactivated by a DCI. Different DCI formats are defined in NR for DL PDSCH scheduling including DCI format 1_0, DCI format 1_1, and DCI format 1_2.

Similarly, UL PUSCH transmission can also be scheduled either dynamically or semi-persistently with uplink grants carried in PDCCH. NR supports two types of semi-persistent uplink transmission, i.e., type 1 configured grant (CG) and type 2 configured grant, where Type 1 configured grant is configured and activated by Radio Resource Control (RRC) while type 2 configured grant is configured by RRC but activated/deactivated by DCI. The DCI formats for scheduling PUSCH include DCI format 0_0, DCI format 0_1 and DCI format 0_2.

### NR PUSCH Transmission Schemes

In NR, two transmission schemes for PUSCH are supported. One is codebook based and the other is non-codebook based. The codebook based PUSCH transmission scheme can be summarized as follows:
The UE transmits Sounding Reference Signal (SRS) in an SRS resource set with a higher layer parameter usage set to ‘codebook’. Up to two SRS resources, each with up to four antenna ports can be configured in the SRS resource set.
The NR base station (gNB) determines an SRS resource and a number of Multiple Input and Multiple Output (MIMO) layers (or rank) and a preferred precoder (i.e., transmit precoding matrix indicator or TPMI) associated with the SRS resource.
The gNB indicates the selected SRS resource via a 1-bit ‘SRS resource indicator’ (SRI) field in a DCI scheduling the PUSCH if two SRS resources are configured in the SRS resource set. The ‘SRS resource indicator’ field is not indicated in DCI if only one SRS resource is configured in the SRS resource set.
The gNB indicates the preferred TPMI and the associated number of layers corresponding to the indicated SRS resource.
The UE performs PUSCH transmission using the TPMI and the number of layers indicated over the SRS antenna ports.

Non-Codebook based UL transmission is for reciprocity-based UL transmission in which SRS precoding is derived at a UE based on a configured DL Channel State Information Reference Signal (CSI-RS). The UE derives a suitable precoder for SRS transmission based on the CSI-RS and creates one or more (virtual) SRS ports, each corresponding to a spatial layer. Up to four SRS resources, each with a single (virtual) SRS port can be configured in an SRS resource set. A UE can transmit SRS in the up to four SRS resources, and the gNB measures UL channel based on the received SRS and determines the preferred SRS resource(s). Subsequently, the gNB indicates the selected SRS resources via an SRS resource indicator (SRI) in a DCI scheduling a PUSCH.

Note that up to Release 16 in NR, only a single SRS resource set can be configured with usage set to “nonCodebook” or “codebook”.

### NR Rel-15 Power Control for PUSCH

Uplink power control is used to determine a proper PUSCH transmit power. The uplink power control in NR consists of two parts, i.e., open-loop and closed-loop power controls. Open-loop power control is determined by a UE and is used to set the uplink transmit power based on the pathloss estimate and some other factors such as the target receive power, scheduled bandwidth, modulation and coding scheme (MCS), fractional power control factor, etc. Closed-loop power control is based on power control commands received from the gNB.

With multi-beam transmission in NR Frequency Range 2 (FR2), the pathloss can be different with different transmit and receive beam pairs. To support transmission with different beam pairs, each beam pair can be associated with a pathloss reference signal (RS). Pathloss associated with a beam pair can be measured based on the associated pathloss RS. A pathloss RS can be a Synchronization Signal (SS) and Physical Broadcast Channel (PBCH) block (SSB) or a CSI-RS.

FIG. 3 shows an example in which, for PUSCH transmitted in beam #1, CSI-RS #1 may be configured as the pathloss reference RS. Similarly, for PUSCH transmitted in beam #2, CSI-RS #2 may be configured as the pathloss reference RS.

For a PUSCH to be transmitted in a UL beam pair associated with a pathloss RS with index k, the PUSCH transmit power in a transmission occasion i within a slot in a bandwidth part (BWP) of a carrier frequency f of a serving cell c and a closed-loop index l (l=0, 1) can be determined as:

$${P}_{b , f , c} ( i , k , l ) = min \{ \begin{matrix}{P}_{C M A X , f , c} ( i ) \\ {P}_{b , f , c , open - loop} ( i , k ) + {P}_{b , f , c , closed - loop} ( i , l )\end{matrix}$$

where P_{CMAX,f,c}(i) is the configured UE maximum output power for the carrier frequency f of the serving cell c in transmission occasion i; P_{b,f,c,closed-loop}(i, l) is the closed loop power adjustment; P_{b,f,c,open-loop}(i, k) is the open loop power adjustment and is given by:

$${P}_{b , f , c , open - loop} ( i , k ) = {P}_{O , b , f , c} ( j ) + {P}_{RB , b , f , c} ( i ) + {α}_{b , f , c} ( j ) P {L}_{b , f , c} ( k ) + {Δ}_{MCS , b , f , c} ( i )$$

where P_{O,b,f,c}(j) is the nominal target receive power for a parameter set configuration with index j and comprises a cell specific part P_{O_Nomina_PUSCH,f,c}(j) and a UE specific part P_{O_UE_PUSCH,b,f,c}(j), P_{RB,b,f,c}(i) is a power adjustment related to the number of RBs scheduled in a transmission occasion i, PL_{b,f,c}(k) is the pathloss estimation based on the pathloss reference signal with index k, α_{b,f,c} is fractional pathloss compensation factor, and Δ_{MCS,b,f,c}(i) is a power adjustment related to MCS.

For PUSCH associated with a random access (RACH) procedure, j=0, and P_{O_UE_PUSCH,b,f,c}(0)=0.

For configured grant based PUSCH, j=1, and P_{O_Nomina_PUSCH,f,c}(1) IS provided by p0-NominalWithoutGrant, or

$${P}_{{O}_{{Nomina}_{PUSCH} , f , c}} ( 1 ) = {P}_{O\_Nomina \_PUSCH , f , c} ( 0 )$$

p0-NominalWithoutGrant is not provided, and P_{O_UE_PUSCH,b,f,c}(1) is provided by p0 obtained from p0-PUSCH-Alpha in ConfiguredGrantConfig that provides an index P0-PUSCH-AlphaSetId to a set of P0-PUSCH-AlphaSet for active UL BWP b of carrier f of serving cell c.

For dynamically scheduled PUSCH, j>1,

$${P}_{{O}_{{Nomina}_{PUSCH} , f , c}} ( j )$$

is provided by p0-NominalWithGrant, or

$${P}_{{O}_{{Nomina}_{PUSCH} , f , c}} ( j ) = {P}_{{O}_{{Nomina}_{PUSCH} , f , c}} ( 0 )$$

if p0-NominalWithGrant is not provided. P_{O_UE_PUSCH,b,f,c}(f) is provided by p0 in a P0-PUSCH-AlphaSet indicated by a respective p0-PUSCH-AlphaSetId for active UL BWP b of carrier f of serving cell c as shown in FIG. 4 (which illustrates signaling of PUSCH power control parameters), where the UE first obtains a sri-PUSCH-PowerControlId from the SRI field and then the p0-PUSCH-AlphaSetId from the sri-PUSCH-PowerControl with the sri-PUSCH-PowerControlId.

If the DCI format also includes an open-loop power control (OLPC) parameter set indication field and a value of the open-loop power control parameter set indication field is ‘1’, the UE determines a value of P_{O_UE_PUSCH,b,f,c}(j) from a first value in a P0-PUSCH-Set with a p0-PUSCH-SetId value mapped to the SRI field value.

If the PUSCH transmission is scheduled by a DCI format that does not include an SRI field, or if SRI-PUSCH-PowerControl is not provided to the UE, j=2. If P0-PUSCH-Set is provided to the UE and the DCI format includes an open-loop power control parameter set indication field, the UE determines a value of P_{O_UE_PUSCH,b,f,c}(j) from:
a first P0-PUSCH-AlphaSet in p0-AlphaSets if a value of the open-loop power control parameter set indication field is ‘0’ or ‘00’
a first value in P0-PUSCH-Set with the lowest p0-PUSCH-SetID value if a value of the open-loop power control parameter set indication field is ‘1’ or ‘01’
a second value in P0-PUSCH-Set with the lowest p0-PUSCH-SetID value if a value of the open-loop power control parameter set indication field is ‘10’
else, the UE determines P_{O_UE_PUSCH,b,f,c}(j) from the value of the first P0-PUSCH-AlphaSet in p0-AlphaSets.

### Existing NR Power Head Room Reporting

The uplink power availability at a UE, or power headroom (PH), needs to be provided to the gNB. A PH Report (PHR) is transmitted from the UE to the gNB when the UE is scheduled to transmit data on PUSCH. A PHR can be triggered periodically or when certain conditions are met such as when the pathloss difference between the current PHR and the last PHR is larger than a configurable threshold.

There are two different types of PHRs defined in NR, i.e., Type 1 and Type 3. Type 1 PHR reflects the power headroom assuming PUSCH-only transmission on a carrier and is defined as the difference between the nominal UE maximum transmit power, P_{CMAX}, and an estimated power for PUSCH transmission with UL shared channel (UL-SCH) per activated Serving Cell. A negative PHR indicates that the per-carrier transmit power is limited by P_{CMAX} at the time of the power headroom reporting for the PUSCH.

The type 1 PHR can be based on either an actual PUSCH transmission carrying the PHR report or a reference PUSCH transmission (aka, a virtual PHR) if the time between a PHR report trigger and the corresponding PUSCH carrying the PHR report is too short for a UE to complete the PHR calculation based on the actual PUSCH. The power control parameters for the reference PUSCH are pre-determined as described in 3GPP Technical Specification (TS) 38.213 v16.4.0 section 7.7.1.

Type 3 PHR is defined as the difference between the nominal UE maximum transmit power, P_{CMAX}, and an estimated power for SRS transmission per activated Serving Cell. It is used for UL carrier switching in which a PHR is reported for a carrier that is not yet configured for PUSCH transmission but is configured only for SRS transmission. Type 3 PHR can be based on either an actual SRS transmission or a reference SRS transmission as described in 3GPP TS 38.213 v16.4.0 section 7.7.3. PHR is per carrier and does not explicitly take beam-based operation into account.

Power Headroom reporting is controlled by configuring the following higher layer parameters as described in 3GPP TS 38.331 V16.4.0:
phr-PeriodicTimer,
phr-ProhibitTimer,
phr-Tx-PowerFactorChange,
phr-Type2OtherCell,
phr-ModeOtherCG,
multiplePHR,
mpe-Reporting-FR2;
mpe-ProhibitTimer,
mpe-Threshold.

According 3GPP TS 38.321 v16.4.0, section 5.4.6, a PHR is triggered if any of a list of events occur, where these events include:
phr-PeriodicTimer expires;
phr-ProhibitTimer expires or has expired and the path loss has changed more than phr-Tx-PowerFactorChange dB for at least one activated Serving Cell of any MAC (Medium Access Control) entity of which the active DL BWP is not dormant BWP which is used as a pathloss reference since the last transmission of a PHR in this MAC entity when the MAC entity has UL resources for new transmission;
upon configuration or reconfiguration of the power headroom reporting functionality by upper layers, which is not used to disable the function;
phr-ProhibitTimer expires or has expired, when the MAC entity has UL resources for new transmission, and the following is true for any of the activated Serving Cells of any MAC entity with configured uplink:
   there are UL resources allocated for transmission on this cell, and the required power backoff due to power management for this cell has changed more than phr-Tx-PowerFactorChange dB since the last transmission of a PHR when the MAC entity had UL resources allocated for transmission on this cell.
if mpe-Reporting-FR2 is configured, and mpe-ProhibitTimer is not running:
   the measured P-MPR (Power Management Maximum Power Reduction) applied to meet FR2 MPE (Maximum Permissible Exposure) requirements as specified in 3gpp TS 38.101-2 is equal to or larger than mpe-Threshold for at least one activated FR2 Serving Cell since the last transmission of a PHR in this MAC entity; or
   the measured P-MPR applied to meet FR2 MPE requirements as specified in TS 3gpp 38.101-2 has changed more than phr-Tx-PowerFactorChange dB for at least one activated FR2 Serving Cell since the last transmission of a PHR due to the measured P-MPR applied to meet MPE requirements being equal to or larger than mpe-Threshold in this MAC entity.
in which case the PHR is referred to as ‘MPE P-MPR report’.

Note that the path loss variation for one cell assessed above is between the pathloss measured at present time on the current pathloss reference and the pathloss measured at the transmission time of the last transmission of PHR on the pathloss reference in use at that time, irrespective of whether the pathloss reference has changed in between.

PHR is carried in a Medium Access Control (MAC) Control Element (CE), which is then carried in a PUSCH. A UE may be configured by higher layers with either a single entry PHR MAC CE or multiple entry PHR MAC CE. In case of single entry PHR MAC CE, only type 1 PHR is reported. In case of multiple entry PHR MAC CE, PHRs for different serving cells may be reported according to 3GPP TS 38.321 v16.4.0 sections 5.4.6, 6.1.3.8 and 6.1.3.9. The single entry MAC CE is shown in FIG. 5 (which is a reproduction of FIG. 6.1.3.8-1 of 3GPP TS 38.321, which is entitled “Single Entry PHR MAC CE”) and multiple entry MAC CE is shown in FIG. 6 (which is a reproduction of FIG. 6.1.3.9-1 of 3GPP TS 38.321, which is entitled “Multiple Entry PHR MAC CE with the highest ServCellIndex of Serving Cell with configured uplink is less than 8”).

The field descriptions for the fields in the single entry and multiple entry PHR MAC CEs is given below:
R: Reserved bit, set to 0;
PH: This field indicates the power headroom level.
P: If mpe-Reporting-FR2 is configured and the Serving Cell operates on FR2, the MAC entity shall set this field to 0 if the applied P-MPR value, to meet MPE requirements, as specified in 3GPP TS 38.101-2, is less than P-MPR_00 as specified in 3GPP TS 38.133 and to 1 otherwise.
P_{CMAX,f,c}: This field indicates the P_{CMAX,f,c} (as specified in 3GPP TS 38.213) used for calculation of the preceding PH field.
V: This field indicates if the PH value is based on a real transmission or a reference format. For Type 1 PH, the V field set to 0 indicates real transmission on PUSCH and the V field set to 1 indicates that a PUSCH reference format is used.
Cᵢ: This field indicates the presence of a PH field for the Serving Cell with ServCellIndex i as specified in 3GPP TS 38.331. The Cᵢ field set to 1 indicates that a PH field for the Serving Cell with ServCellIndex i is reported. The Cᵢ field set to 0 indicates that a PH field for the Serving Cell with ServCellIndex i is not reported;
MPE: If mpe-Reporting-FR2 is configured, and the Serving Cell operates on FR2, and if the P field is set to 1, this field indicates the applied power backoff to meet MPE requirements, as specified in 3GPP TS 38.101-2. The length of the field is 2 bits. If mpe-Reporting-FR2 is not configured, or if the Serving Cell operates on FR1, or if the P field is set to 0, R bits are present instead.

### NR Release 17 Enhancements on PUSCH Transmission Towards Two Transmission and Reception Points (TRPS)

A TRP is a set of geographically co-located transmit and receive antennas such as base station antennas, remote radio heads, a remote antenna of a base station, etc. A serving cell can have one TRP or multiple TRPs. In NR Release 17, it has been agreed that PUSCH repetition to two TRPs in a cell will be supported. For that purpose, two SRS resource sets with usage set to either ‘codebook’ or ‘nonCodebook’ will be introduced, each SRS resource set is associated with a TRP. PUSCH repetition to two TRPs can be scheduled by a DCI with two SRS resource indicator (SRI) fields, where a first SRI is associated with a first SRS resource set and a second SRI is associated with a second SRS resource set.

An example is shown in FIG. 7, where a PUSCH repetition towards two TRPs is scheduled by a DCI indicating two SRIs. Both type A and type B PUSCH repetitions are supported.

Two types of mappings are supported between PUSCH transmission occasions and TRPs or UL beams, i.e.
Cyclical Mapping Pattern: The first and second UL beams are applied to the first and second PUSCH repetitions, respectively, and the same beam mapping pattern continues to the remaining PUSCH repetitions.
Sequential Mapping Pattern: The first beam is applied to the first and second PUSCH repetitions, and the second beam is applied to the third and fourth PUSCH repetitions, and the same beam mapping pattern continues to the remaining PUSCH repetitions.
   The first and second UL beams are used to transmit PUSCH towards the first and second TRPs, respectively.

It has been agreed that two sets of power control parameters will be supported, each set is associated with an SRI field in DCI formats 0_1 and 0_2.

### Uplink Transmission Configuration Indicator (TCI)

In NR Release 15/16, a UE can be configured with a list of TCI State configurations for decoding PDSCH. Each TCI State contains parameters for configuring a Quasi Co-Location (QCL) relationship between one or two downlink reference signals, also referred to as QCL source reference signal (RS), and the Demodulation Reference Signal (DM-RS) ports of the PDSCH, the DM-RS port of PDCCH, or the CSI-RS port(s) of a CSI-RS resource. If a QCL source RS is indicated for a PDSCH, then certain large-scale channel properties associated with the PDSCH can be derived from the QCL source RS. The large-scale channel property can be Doppler shift, Doppler spread, average delay spread, or average delay. In NR, four types of QCL relations were defined, i.e.,
Type A: {Doppler shift, Doppler spread, average delay, delay spread}
Type B: {Doppler shift, Doppler spread}
Type C: {average delay, Doppler shift}
Type D: {Spatial Rx parameter}

A TCI state can contain on QCL RS with type A, type B or type C and in case of FR2, also a QCL RS with type D. The QCL source RS can be either a SSB or a CSI-RS. For example, if a TCI state contains a pair of reference signals, {CSI-RS1, CSI-RS2}, and {qcl-Type1,qcl-Type2}={Type A, Type D}. It means the UE can derive Doppler shift, Doppler spread, average delay, delay spread from CSI-RS1 and Spatial Rx parameter (i.e., the RX beam or spatial domain receive filter) from CSI-RS2.

In NR Release 15 and 16, the spatial transmission properties, i.e., spatial domain transmit filter or UL beam, for PUSCH are given by the spatial transmission properties of the associated SRS resource in an SRS resource set with usage set to ‘Codebook’ or ‘nonCodebook’. To enhance UL transmission, uplink TCI states are also proposed for NR Release 17 in which TCI states may be used to control the spatial properties of all UL transmissions (i.e., PUSCH, PUCCH, and SRS). There are different possible ways of configuring uplink TCI state. In one case, the UL TCI states are dedicated to only uplink and are configured separately from the TCI states corresponding to downlink. For example, the UL TCI states can be configured as part of the PUSCH-Config information element. Each uplink TCI state may indicate a transmission configuration which contains a DL RS (e.g., CSI-RS or SSB) or an UL RS (e.g., SRS) with the purpose of indicating a spatial relation for PUSCH DMRS. Alternatively, the UL TCI states may be configured as part of BWP-UplinkDedicated information element such that the same UL TCI state can be used to indicate a DL RS or UL RS which provides the spatial relation for more than one of PUSCH DMRS, PUCCH DMRS, and SRS. In another case, the same list of TCI states is used for both DL and UL, hence the UE is configured with a single list of TCI states which can be used for both UL and DL scheduling. The single list of TCI states is referred to as unified UL/DL TCI states. The single list of TCI states in this case are configured as part of, for example the PDSCH-Config or the BWP-UplinkDedicated information elements.

### SUMMARY

Systems and methods for power headroom reporting for uplink transmissions towards multiple Transmission and Reception Points (TRPs) are disclosed. In one embodiment, a method performed by a wireless communication device comprises receiving, from a base station, downlink control information or a configuration that schedules an uplink transmission with two or more repetitions, wherein each of the two or more repetitions is associated to a different one of two or more Sounding Reference Signal (SRS) resource sets and a different one of two or more power headrooms (PHs) and a power headroom report (PHR) is triggered and is to be carried by the uplink transmission. The method further comprises calculating at least one PH among the two or more PHs, constructing a PHR Medium Access Control (MAC) Control Element (CE) comprising the at least one PH, and transmitting the PHR MAC CE in the uplink transmission. In this manner, the base station is enabled to receive PH information for all TRPs in a cell, which further enables the network node to make better scheduling decisions on uplink transmissions to multiple TRPs.

In one embodiment, the uplink transmission is a Physical Uplink Shared Chanel (PUSCH) transmission.

In one embodiment, the at least one PH is calculated based on a first transmission occasion in time from among those scheduled for the two or more repetitions. In one embodiment, the method further comprises receiving, from the base station, information that indicates which SRS resource set from among the two or more SRS resource sets is associated to the first transmission occasion. In one embodiment, the at least one PH comprised in the PHR MAC CE is a PH associated to the SRS resource set associated to the first transmission occasion. In one embodiment, different SRS resource sets may be indicated as being associated to first transmission occasions for different scheduled uplink transmissions. In one embodiment, the information that indicates which SRS resource set from among the two or more SRS resource sets is associated to the first transmission occasion is comprised in the downlink control information. In one embodiment, a single bitfield in the downlink control information is used to jointly encode whether the two or more repetitions are associated to a single SRS resource set or multiple SRS resource sets among the two or more SRS resource sets and which SRS resource set from among the two or more SRS resource sets is associated to the first transmission occasion.

In one embodiment, the SRS resource set from among the two or more SRS resource sets that is associated with the first transmission occasion can be changed in different time periods.

In one embodiment, the PHR MAC CE comprises information that indicates one of the two or more SRS resource sets associated to each of the at least one PH comprised in the PHR MAC CE.

In one embodiment, the at least one PH is a PH associated to one of the two or more SRS resource sets, and the PHR MAC CE comprises information that indicates the one of the two or more SRS resource sets associated to the PH comprised in the PHR MAC CE.

In one embodiment, (a) the two or more repetitions consist of a first repetition associated to a first SRS resource set and a second repetition associated to a second SRS resource set; (b) the at least one PH value is either: (i) a PH value associated to one of the first and second SRS resource sets or (ii) both a first PH value associated to the first SRS resource set and a second PH value associated to the second SRS resource set; (c) the PHR MAC CE comprises information that indicates whether the PHR MAC CE comprises: (i) a PH value associated to one of the first and second SRS resource sets or (ii) both a first PH value associated to the first SRS resource set and a second PH value associated to the second SRS resource set; or (d) any combination of two or more of (a)-(c).

In one embodiment, separate power control parameters are associated to the two or more SRS resource sets, and calculating the at least one PH value comprises, for transmission occasion i on active uplink bandwidth part b of carrier f of serving cell c, calculating a PH value as:

$${PH}_{type 1 , b , f , c} ( i , j , {q}_{d} , l ) = {\tilde{P}}_{CMAX , f , c} ( i ) - \{ {P}_{O\_PUSCH , b , f , c} ( j ) + {α}_{b , f , c} ( j ) \cdot {PL}_{b , f , c} ( {q}_{d} ) + {f}_{b , f , c} ( i , l ) \} [ dB ]$$

where:
   b is a bandwidth part index;
   f is a carrier frequency index;
   c is a cell index;
   i is transmission occasion index;
   j is an index of PUSCH type;
   q_{d} is a pathloss reference RS index;
   l is a closed-loop index;
   \tilde{P}_{CMAX,f,c}(i) is a wireless communication device maximum output power for carrier frequency f of serving cell c in transmission occasion i;
   P_{O}_{_{PUSCH}}_{,b,f,c}(j) is a parameter composed of the sum of a component P_{O_NOMINAL_PUSCH,b,f,c}(j) and a component P_{O_UE_PUSCH,b,f,c}(j);
   α_{b,f,c}(j) is α_{b,f,c} is a fractional pathloss compensation factor;
   PL_{b,f,c}(q_{d}) is a pathloss estimation based on a pathloss reference signal with index qai
   f_{b,f,c}(i, l) is a PUSCH power control adjustment state (for active uplink bandwidth part b of carrier f of serving cell c and PUSCH transmission occasion i.

In one embodiment, the method further comprises detecting a triggering event for a PHR. In one embodiment, the triggering event is when a PHR timer has expired and a pathloss has changed more than a threshold amount since a last transmission of a PHR, wherein the pathloss change is with respect to any pathloss reference signal among one or multiple pathloss reference signals configured in a same uplink power control parameter set associated with one of the two or more SRS resource sets. In another embodiment, the triggering event is when a timer has expired and a pathloss associated to any one of the two or more SRS resource sets has changed more than a threshold amount since a last transmission of a PHR. In one embodiment, different timers are associated to different SRS resource sets.

In one embodiment, the PHR MAC CE is in accordance with a defined PHR MAC CE format that can carry multiple PHs.

Corresponding embodiments of a wireless communication device are also disclosed. In one embodiment, a wireless communication device is adapted to receive, from a base station, downlink control information or a configuration that schedules an uplink transmission with two or more repetitions, wherein each of the two or more repetitions is associated to a different one of two or more SRS resource sets and a different one of two or more PHs and a PHR is triggered and is to be carried by the uplink transmission. The wireless communication device is further adapted to calculate at least one PH among the two or more PHs, construct a PHR MAC CE comprising the at least one PH, and transmit the PHR MAC CE in the uplink transmission.

In another embodiment, a wireless communication device comprises one or more transmitters, one or more receivers, and processing circuitry associated with the one or more transmitters and the one or more receivers. The processing circuitry is configured to cause the wireless communication device to receive, from a base station, downlink control information or a configuration that schedules an uplink transmission with two or more repetitions, wherein each of the two or more repetitions is associated to a different one of two or more SRS resource sets and a different one of two or more PHs and a PHR is triggered and is to be carried by the uplink transmission. The processing circuitry is further configured to cause the wireless communication device to calculate at least one PH among the two or more PHs, construct a PHR MAC CE comprising the at least one PH, and transmit the PHR MAC CE in the uplink transmission.

Embodiments of a method performed by a base station are also disclosed. In one embodiments, a method performed by a base station comprises transmitting, to a wireless communication device, downlink control information or a configuration that schedules an uplink transmission with two or more repetitions, wherein each of the two or more repetitions is associated to one of two or more SRS resource sets and a different one of two or more PHs. The method further comprises receiving from the wireless communication device a PHR carried over the uplink transmission, the PHR comprising at least one PH among the two or more PHs.

In one embodiment, the PHR is carried in a PHR MAC CE and comprises information that indicates the at least one of the two or more SRS resource sets associated to the at least one PH comprised in the PHR.

In one embodiment, the PHR MAC CE used to provide the PHR comprises at least one PH, and the at least one PH is calculated based on a first transmission occasion in time from among those scheduled for the two or more repetitions. In one embodiment, the method further comprises transmitting, to the wireless communication device, information that indicates which SRS resource set from among the two or more SRS resource sets is associated to the first transmission occasion. In one embodiment, the at least one PH comprised in the PHR MAC CE is a PH associated to the SRS resource set associated to the first PUSCH transmission occasion. In one embodiment, different SRS resource sets may be indicated as being associated to first transmission occasions for different scheduled uplink transmissions. In one embodiment, the information that indicates which SRS resource set from among the two or more SRS resource sets is associated to the first transmission occasion is comprised in the downlink control information. In one embodiment, a single bitfield in the downlink control information is used to jointly encode whether the two or more repetitions are associated to a single SRS resource set or multiple SRS resource sets among the two or more SRS resource sets and which SRS resource set from among the two or more SRS resource sets is associated to the first transmission occasion.

In one embodiment, the PHR MAC CE that carries the PHR comprises either or both of: a PH associated to one of the two or more SRS resource sets and information that indicates the one of the two or more SRS resource sets associated to each if the at least one PH comprised in the PHR MAC CE.

In one embodiment, (a) the two or more repetitions consist of a first repetition associated to a first SRS resource set and a second repetition associated to a second SRS resource set; (b) the PHR MAC CE used to provide the PHR comprises at least one PH value, the at least one PH value being either: (i) a PH value associated to one of the first and second SRS resource sets or (ii) both a first PH value associated to the first SRS resource set and a second PH value associated to the second SRS resource set; (c) the PHR MAC CE comprises information that indicates whether the PHR MAC CE comprises: (i) a PH value associated to one of the first and second SRS resource sets or (ii) both a first PH value associated to the first SRS resource set and a second PH value associated to the second SRS resource set; or (d) any combination of two or more of (a)-(c).

In one embodiment, the PHR MAC CE used to provide the PHR comprises two or more PHs, and the PHR MAC CE is in accordance with a defined PHR MAC CE format that can carry multiple PHs.

Corresponding embodiments of a base station are also disclosed. In one embodiment, a base station is adapted to transmit, to a wireless communication device, downlink control information or a configuration that schedules an uplink transmission with two or more repetitions, wherein each of the two or more repetitions is associated to one of two or more SRS resource sets and a different one of two or more PHs. The base station is further adapted to receive from the wireless communication device a PH, carried over the uplink transmission, the PHR comprising at least one PH among the two or more PHs.

In another embodiment, a base station comprises processing circuitry configured to cause the base station to transmit, to a wireless communication device, downlink control information or a configuration that schedules an uplink transmission with two or more repetitions, wherein each of the two or more repetitions is associated to one of two or more SRS resource sets and a different one of two or more PHs. The processing circuitry is further configured to cause the base station to receive from the wireless communication device a PH, carried over the uplink transmission, the PHR comprising at least one PH among the two or more PHs.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of a slot in Third Generation Partnership Project (3GPP) New Radio (NR);

FIG. 2 illustrates the basic NR physical time-frequency resource grid;

FIG. 3 illustrates an example in which, for Physical Uplink Shared Channel (PUSCH) transmitted in beam #1, Channel State Information Reference Signal (CSI-RS) #1 (CSI-RS #1) may be configured as the pathloss reference reference signal (RS) and, for PUSCH transmitted in beam #2, CSI-RS #2 may be configured as the pathloss reference RS;

FIG. 4 illustrates signaling of PUSCH power control parameters;

FIG. 5 is a reproduction of FIG. 6.1.3.8-1 of 3GPP Technical Specification (TS) 38.321, which is entitled “Single Entry PHR MAC CE”;

FIG. 6 is a reproduction of FIG. 6.1.3.9-1 of 3GPP TS 38.321, which is entitled “Multiple Entry PHR MAC CE with the highest ServCellIndex of Serving Cell with configured uplink is less than 8”;

FIG. 7 illustrates an example in which a PUSCH repetition towards two Transmission and Reception Points (TRPs) is scheduled by a Downlink Control Information (DCI) indicating two Sounding Reference Signal (SRS) Resource Indicators (SRIs);

FIG. 8 illustrates an example in which a PUSCH repetition is scheduled to two TRPs, wherein the transmit power of PUSCH corresponding to the two TRPs are different;

FIG. 9 illustrates one example of a cellular communications system in which embodiments of the present disclosure may be implemented;

FIG. 10 shows an example of a serving cell with two TRPs under control of a base station in accordance with example embodiments of the present disclosure;

FIG. 11 illustrates an example embodiment identifying PUSCH power control parameters associated with the first or second SRI or SRS resource set;

FIG. 12 illustrates an example embodiment of a Power Headroom (PHR) Medium Access Control (MAC) Control Element (CE) that includes an indication of which TRP (or the associated SRS resource set) with which a reported Power Headroom (PH) value is associated;

FIG. 13 illustrates an example embodiment of a PHR MAC CE that includes PH values for two TRPs (or two associated SRS resource sets);

FIG. 14 illustrates an example embodiment for obtaining PH values for multiple TRPs by associating different TRPs to the first PUSCH transmission occasion over time;

FIG. 15 illustrates an example embodiment in which TRP toggling is used in case of Type 1 Configured Grant (CG) with PUSCH repetition towards multiple TRPs;

FIG. 16 illustrates an example embodiment in which PHR is triggered when pathloss has been changed by more than a threshold since the last PHR;

FIG. 17 illustrates an example embodiment of a PHR MAC CE carrying two PH values, one for each TRP;

FIG. 18 illustrates an example embodiment of a PHR MAC CE carrying one PH value per cell;

FIG. 19 illustrates the operation of a wireless communication device (WCD) and a base station in accordance with at least some of the embodiments described herein;

FIGS. 20, 21, and 22 are schematic block diagrams of example embodiments of a network node;

FIGS. 23 and 24 are schematic block diagrams of example embodiments of a WCD;

FIG. 25 illustrates an example embodiment of a communication system in which embodiments of the present disclosure may be implemented;

FIG. 26 illustrates example embodiments of the host computer, base station, and UE of FIG. 25; and

FIGS. 27, 28, 29, and 30 are flow charts that illustrate example embodiments of methods implemented in a communication system such as that of FIG. 25.

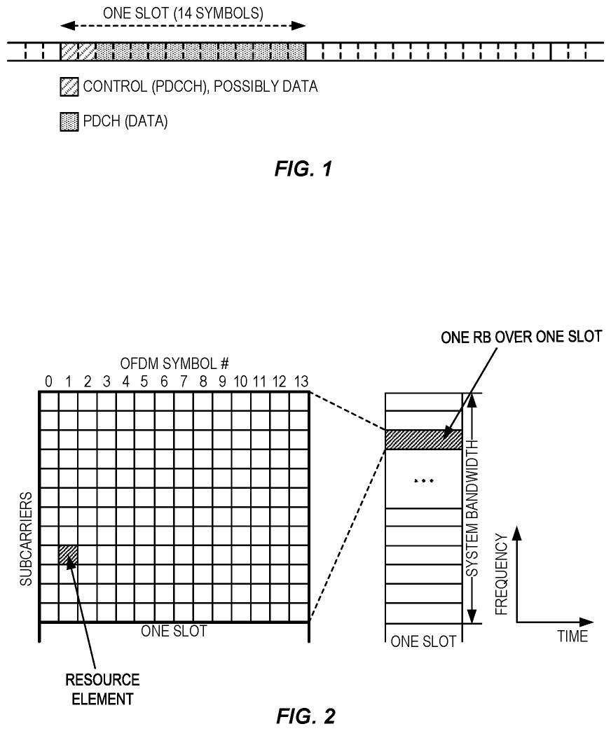

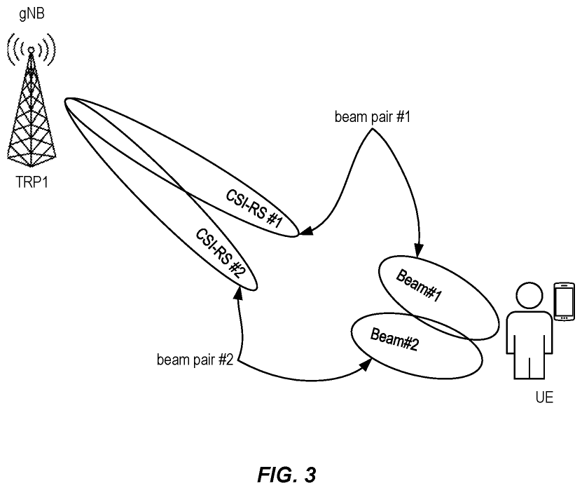

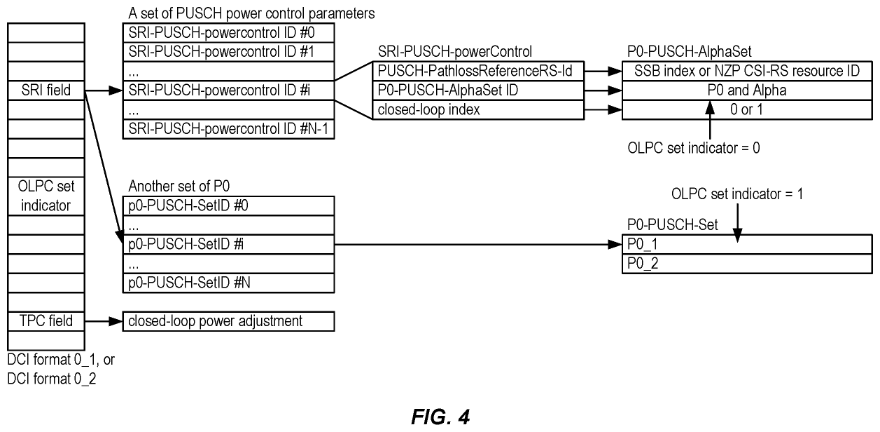

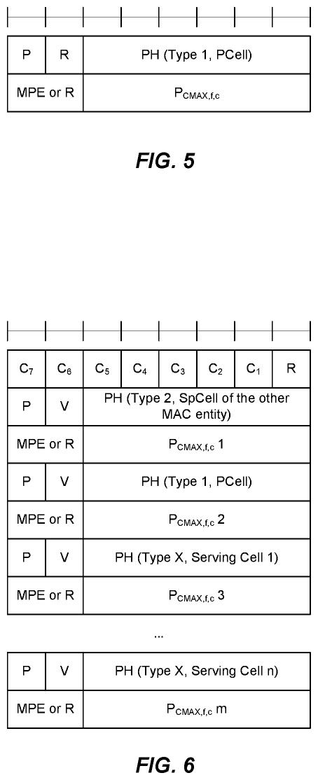

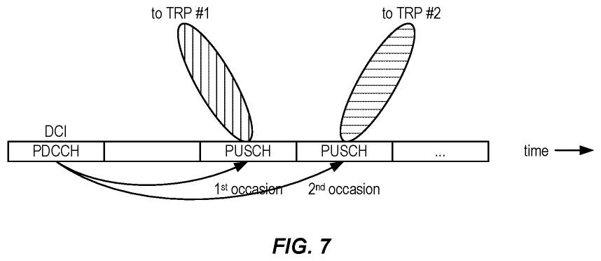

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may be represented by an SRS resource set, an SRI field in UL scheduling DCI, a spatial relation, or an UL TCI state. Hence, a UE transmitting PUSCH towards a TRP may be equivalent to any one of the following:
The UE transmitting PUSCH using the SRI(s) indicated by the SRI field in the UL scheduling DCI representing the TRP,
The UE transmitting PUSCH using the SRI(s) from the SRS resource set representing the TRP,
The UE transmitting PUSCH using the spatial relation representing the TRP, or
The UE transmitting PUSCH using the UL TCI state representing the TRP.

In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

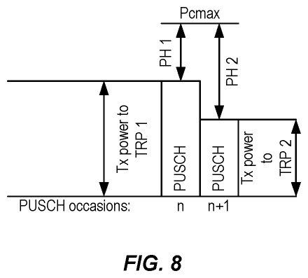

There currently exist certain challenge(s). When a Power Headroom Report (PHR) is to be carried on a Physical Uplink Shared Channel (PUSCH) that is to be repeated towards different TRPs, different transmit powers may be determined for different PUSCH occasions. For PHR calculation based on an actual PUSCH, if the PHR carrying PUSCH is repeated towards different TRPs, which PUSCH occasion to be used for calculating the PHR is an open issue. An example is shown in FIG. 8, where a PUSCH repetition is scheduled to two TRPs, wherein the transmit power of PUSCH corresponding to the two TRPs are different.

The following options have been proposed:
Option 1: use the first PUSCH occasion for calculating the PHR,
Option 2: calculate two PHRs, each associated with a first PUSCH occasion to each TRP, but report one of them (e.g., the one with the smallest value), and
Option 3: calculate two PHRs, each associated with a first PUSCH occasion to each TRP, and report both of the two PHRS.

In Option 1, a PHR associated with one TRP is always reported. This is not desirable because the UE may run out of power towards the other TRP if the Power Headroom (PH) for the other TRP is smaller than the reported one as the gNB does not know the PH of the other TRP.

In Option 2, one PHR is selected by the UE to report. However, it is unclear how the selection is done. If the one with smallest value is always selected, then the scheduling would be more conservative. On the other hand, if the one with the largest value is selected, the scheduling would be more aggressive.

In Option 3, PHRs for both TRPs are reported. This option provides the full PH information for each TRP, which should help the gNB to make better scheduling decisions. However, how to report two PHRs for a serving cell is an open issue.

Certain aspects of the present disclosure and their embodiments may provide solutions to the aforementioned or other challenges. In one embodiment, one PH per serving cell is reported by a UE when the UE is configured with PUSCH repetitions to multiple TRPs in a serving cell. The PH is calculated based PUSCH transmission to one of the TRPs according to some rules (e.g., toggling between two TRPs). The UE explicitly indicates in a PHR Medium Access Control (MAC) Control Element (CE) which TRP the reported PH is associated with.

In another embodiment, a PH is always calculated based on the first PUSCH transmission occasion, and the UE may be indicated by the gNB which TRP the first PUSCH transmission occasion of a PUSCH repetition should be transmitted to. By associating different TRPs with the first PUSCH transmission occasion, the gNB can obtain PHs for all TRPs in a serving cell.

In a further embodiment, a new PHR MAC CE is proposed to carry PHs for all TRPs in a serving cell when a PHR is triggered.

Embodiments of systems and methods for reporting PH for multiple TRPs in a cell where a PUSCH may be sent to one of the TRPs or may be repeated towards different TRPs in different slots are disclosed herein. Embodiments of the present disclosure may include any one or more of the following aspects:
A wireless communication device (e.g., a UE) explicitly indicating, in a (new) PHR MAC CE, the TRP(s) to which a PH in a PHR is associated;
A wireless communication device (e.g., a UE) explicitly indicating, in a (new) PHR MAC CE, whether one or two PHs are reported for a cell;
PHR triggering with TRP specific pathloss change conditions;
Toggling, by a network node (e.g., a base station such as, e.g., a gNB), TRPs associated with a first PUSCH transmission occasion in case of PUSCH repetition to multiple TRPs and reporting, by the wireless communication device (e.g., UE), PH for only a TRP associated with the first PUSCH occasion.

Certain embodiments may provide one or more of the following technical advantage(s). Embodiments of the present disclosure may enable a network node (e.g., a base station such as, e.g., a gNB) to get power head room information for all TRPs in a cell and to make better scheduling decisions on PUSCH transmissions to multiple TRPs.

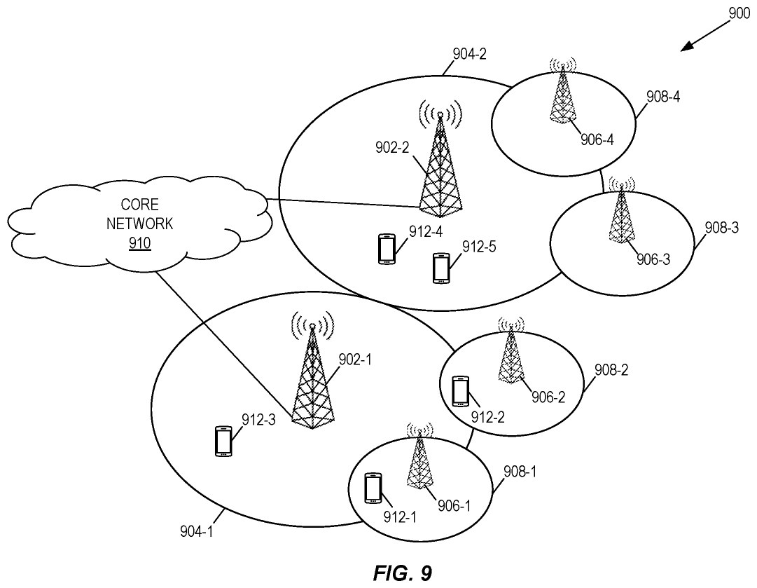

FIG. 9 illustrates one example of a cellular communications system 900 in which embodiments of the present disclosure may be implemented. In the embodiments described herein, the cellular communications system 900 is a 5G system (5GS) including a Next Generation RAN (NG-RAN) and a 5G Core (5GC); however, the embodiments described herein are equally applicable to any type of wireless or cellular communications system in which it is desirable to a wireless communication device to provide power headroom (PH) reports (PHRs) in association with uplink transmission to multiple TRPs. In this example, the RAN includes base stations 902-1 and 902-2, which in the 5GS include NR base stations (gNBs) and optionally next generation eNBs (ng-eNBs), controlling corresponding (macro) cells 904-1 and 904-2. The base stations 902-1 and 902-2 are generally referred to herein collectively as base stations 902 and individually as base station 902. Likewise, the (macro) cells 904-1 and 904-2 are generally referred to herein collectively as (macro) cells 904 and individually as (macro) cell 904. The RAN may also include a number of low power nodes 906-1 through 906-4 controlling corresponding small cells 908-1 through 908-4. The low power nodes 906-1 through 906-4 can be small base stations (such as pico or femto base stations) or RRHs, or the like. Notably, while not illustrated, one or more of the small cells 908-1 through 908-4 may alternatively be provided by the base stations 902. The low power nodes 906-1 through 906-4 are generally referred to herein collectively as low power nodes 906 and individually as low power node 906. Likewise, the small cells 908-1 through 908-4 are generally referred to herein collectively as small cells 908 and individually as small cell 908. The cellular communications system 900 also includes a core network 910, which in the 5GS is the 5GC. The base stations 902 (and optionally the low power nodes 906) are connected to the core network 910.

The base stations 902 and the low power nodes 906 provide service to wireless communication devices 912-1 through 912-5 in the corresponding cells 904 and 908. The wireless communication devices 912-1 through 912-5 are generally referred to herein collectively as wireless communication devices 912 and individually as wireless communication device 912. In the following description, the wireless communication devices 912 are oftentimes UEs and as such sometimes referred to herein as UEs 912, but the present disclosure is not limited thereto.

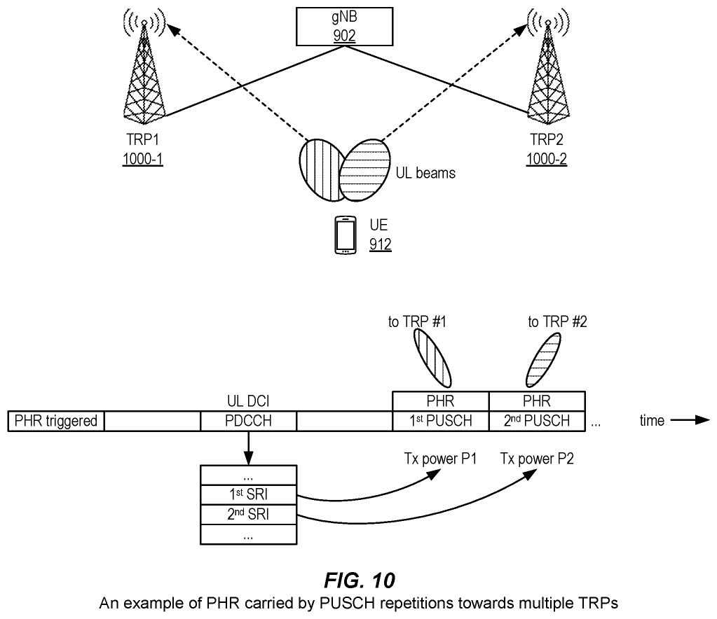

FIG. 10 shows an example of a serving cell with two TRPs 1000-1 and 1000-2 under control of a base station 902. In this example, the base station 902 is a gNB and as such is sometimes referred to herein as a gNB 902. A wireless communication device (WCD) 912 in the serving cell is configured with two SRS resource sets, each associated with one of the two TRPs 1000-1, 1000-2. In this example, the WCD 912 is a UE and as such is sometimes referred to herein as a UE 912. Each SRS resource set is associated with an SRS resource set index. The UE 912 may be scheduled by the gNB 902 to transmit a PUSCH towards one of the TRPs 1000-1, 1000-2 or towards different TRPs in different time instances such as different slots, i.e., a PUSCH is repeated in multiple occasions each towards one of the two TRPs 1000-1, 1000-2.

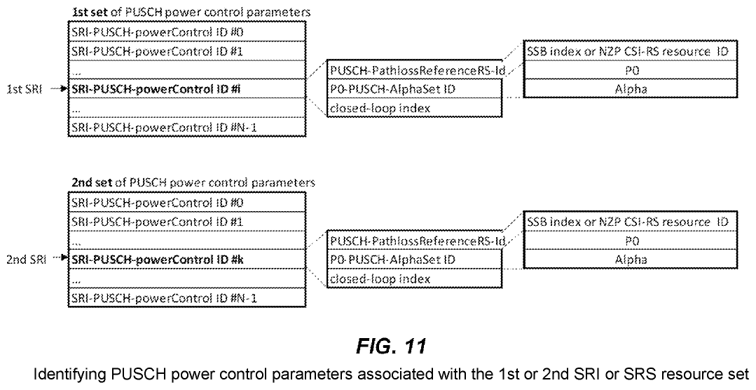

PUSCH repetition to the two TRPs 1000-1, 1000-2 can be indicated either in a DCI scheduling the PUSCH transmission or in a configured grant configuration with two SRIs. Each of the two SRIs is associated with one of the two SRS resource sets. The mapping between the SRIs and the PUSCH transmission occasions can be configured (e.g., in a cyclic or sequential manner). The first PUSCH transmission may be associated with the first or second SRI. The first SRI may be used to indicate an SRS resource in the first SRS resource set, and the second SRI field may be used to indicate an SRS resource set in the second SRS resource set. The first SRS resource set may be identified as the one with a lowest SRS resource set index. PUSCH in a transmission occasion associated with an SRI is transmitted over SRS antenna ports of the SRS resource indicated by the SRI. The SRI is also used to select the corresponding PUSCH power control parameters from a set of PUSCH power control parameters configured for the corresponding SRS resource set. For each SRS resource set, a separate set of PUSCH power control parameters are configured. For a PUSCH transmission occasion, the associated power control parameters (i.e., pathloss reference RS, P0, and α) is determined using the associated SRI as illustrated in FIG. 11.

The following subsections describe embodiments that define how to calculate and report PHR when PHR is triggered in the serving cell and the first available PUSCH transmission for new data is in a PUSCH repetition towards the two TRPs. Note while the embodiments are described in these separate subsections, it is to be understood that the embodiments described in the subsections below can be used separately or in any desired combination.

Throughout this disclosure, the term PUSCH transmission towards two or more TRPs is used. This means that the UE uses different (e.g., two or more) spatial transmission filters and/or power control parameter sets to target the PUSCH transmission towards two or more TRPs. The spatial transmission filter and/or power control parameter set information to be used by the UE to transmit a PUSCH towards a TRP is indicated to the UE via an SRI or a UL TCI state. If a UE is to target PUSCH towards two different TRPs, then two SRIs or two UL TCI states need to be indicated to the UE.

UE Indicating a TRP Associated with a PH in a PHR

When PUSCH repetition to multiple TRPs is configured for a UE, i.e., the UE is configured with multiple SRS resource sets with usage set to either ‘codebook’ or ‘nonCodebook’ and one or more PHRs are triggered, a single PHR is reported for each activated cell. If a Type 1 PHR is determined to be calculated based on an actual PUSCH and the PUSCH is part of a PUSCH repetition towards multiple TRPs, in one embodiment, a PH associated with a PUSCH transmission occasion towards one of the TRPs is reported according one or more rules. In one example, the UE may toggle between two TRPs in two adjacent PHR reporting instances so that the gNB can have PH for each TRP. In other words, for a given serving cell with two TRPs, the UE may report PH for one TRP in a first PHR and another PH for the other TRP in another PHR, and this may be done in an alternating manner.

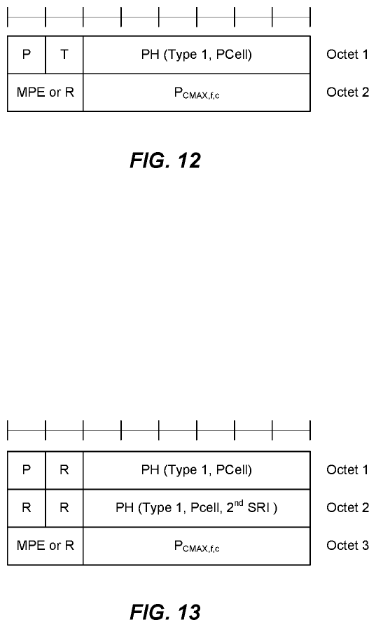

The UE indicates in a PHR MAC CE which TRP (or the associated SRS resource set) a reported PH is associated with, i.e., the PH is calculated based on a PUSCH transmit power towards the TRP. An example is shown in FIG. 12, where the T bit field is used to indicate whether the PH is associated with a first TRP (e.g., TRP 1000-1) or second TRP (e.g., TRP 1000-2). For example, T=0 and T=1 may indicate the first TRP and the second TRP, respectively. The first and second TRPs are associated, respectively, with either first and second SRS resource sets or first and second SRI fields in a DCI.

In another embodiment, there are the following two UE behaviors when it comes to reporting PH(s) in a PHR MAC CE:
Behavior 1: The UE reports a single PH in a PHR MAC CE. Specifically, the UE indicates in a PHR MAC CE which TRP (or the associated SRS resource set) a reported PH corresponds to. That is, the UE indicates in a PHR MAC CE which PUSCH transmit power among the PUSCH transmit powers associated with two TRPs (e.g., two SRS resource sets) is used to calculate PH.
Behavior 2: The UE reports two PHs in a PHR MAC CE where the two PHs are calculated using the PUSCH transmit power associated with two TRPs (e.g., two SRS resource sets).

In this embodiment, whether the UE should follow behavior 1 or behavior 2 is configured to the UE either implicitly or explicitly. In the explicit configuration approach, a higher layer parameter (e.g., RRC parameter) is configured, e.g., as part of the PHR-Config information element in 3GPP TS 38.331 V16.4.1. In the implicit configuration approach, a UE sets the length field of the PHR MAC CE depending on whether the UE follows behavior 1 or behavior 2. For example, if the length field indicates 2 octets, the UE follows behavior 1 and the PHR MAC CE has a structure similar to FIG. 12. If the length field indicates 3 octets, the UE follows behavior 2 and the PHR MAC CE has a structure similar to FIG. 13. In FIG. 13, the PH corresponding to the first TRP (or first SRS resource set) is in the first octet, and the PH corresponding to the second TRP (or second SRS resource set) is in the second octet.

In an alternative embodiment, a flag (or field) in the PHR MAC CE indicates if the UE reports PH(s) according to behavior 1 or behavior 2. For example, if the flag is set, the UE reports a single PH in the PHR MAC CE according to behavior 1. If the flag is not set, the UE reports two PHs in the PHR MAC CE according to behavior 2. In this alternative embodiment, the flag essentially controls whether the 2^{nd} PH is reported or not in the PHR MAC CE. Hence, the PHR MAC CE in this alternative embodiment is a variable size MAC CE whose size is controlled by the flag.

gNB Indicating a TRP Associated with a First PUSCH Occasion

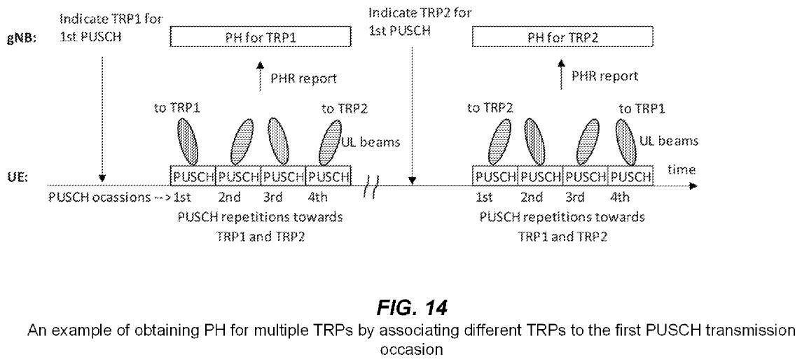

In another embodiment, a PH is always calculated based on the first PUSCH transmission occasion, and the gNB may indicate, to the UE, the TRP to which the first PUSCH transmission occasion of a PUSCH repetition should be transmitted. The indication can be done, e.g., via either a DCI or a MAC CE. For example, a bit field in DCI may indicate whether the first SRI field in DCI is associated with a first or second SRS resource set and the first PUSCH transmission occasion is always associated with the first SRI field. Alternatively, a MAC CE may be used to map between an SRI field and an SRS resource set, and it may be applicable to both dynamically scheduled PUSCH and semi-persistently scheduled PUSCH, i.e., configured grants. By associating different TRPs with the first PUSCH transmission occasion, the gNB can obtain PHs for all TRPs in an activated cell. An example is shown in FIG. 14.

Table 1 below shows an example of using a bit field in DCI to indicate whether a PUSCH transmission is towards a single TRP (STRP) or multiple TRPs (mTRP) and, in case of mTRP, which TRP the first PUSCH transmission occasion is towards.

TABLE 1
An example of using a bit field of 2 bits in DCI to indicate
whether a PUSCH transmission is to a single TRP (sTRP) or a
PUSCH repetition to multiple TRPs (mTRP) and in case of mTRP,
which TRP the first PUCCH transmission occasion is towards.

| codepoint | PUSCH transmission | PHR |
|---|---|---|
| 00 | sTRP to the 1^{st} TRP | For 1^{st} |
| | | TRP |
| 01 | sTRP to the 2^{nd} TRP | For 2^{nd} |
| | | TRP |
| 10 | mTRP: 1^{st} PUSCH transmission to the | For 1^{st} |
| | 1^{st} TRP | TRP |
| 11 | mTRP: 1^{st} PUSCH transmission to the | For 2^{nd} |
| | 2^{nd} TRP | TRP |

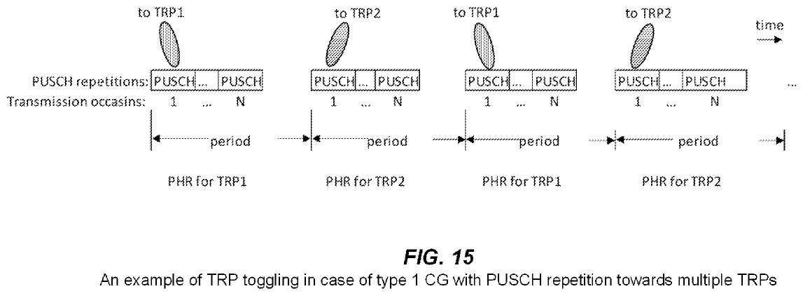

In case of type 1 CG based PUSCH repetition to multiple TRPs, the PUSCH transmission is not scheduled by DCI. In this case, to be able to obtain PHRs for both TRPs, in one embodiment, the TRP for the 1st PUSCH transmission occasion may be toggled in different periods. An example is shown in FIG. 15. If PHR is triggered in a CG period, a PHR for the TRP associated with the 1st PUSCH transmission occasion is reported in a MAC CE carried in the PUSCH.

### PH Calculation Based on a Reference PUSCH Format

In case of PUSCH repetition to multiple TRPs, separate sets of power control parameters (i.e., P0, alpha, pathloss reference RS, closed-loop indices) are configured for different TRPs of SRS resource sets. If the UE determines that a Type 1 power headroom report for an activated serving cell is based on a reference PUSCH transmission then, for PUSCH transmission occasion i on active UL BWP b of carrier f of serving cell c, the UE computes the Type 1 power headroom report as:

$${PH}_{type 1 , b , f , c} ( i , j , {q}_{d} , l ) = {\tilde{P}}_{CMAX , f , c} ( i ) - \{ {P}_{O\_PUSCH , b , f , c} ( j ) + {α}_{b , f , c} ( j ) \cdot {PL}_{b , f , c} ( {q}_{d} ) + {f}_{b , f , c} ( i , l ) \} [ dB ]$$

Where \tilde{P}_{CMAX,f,c}(i) is computed assuming MPR=0 dB, A-MPR=0 dB, P-MPR=0 dB, ΔT_{C}=0 dB. MPR, A-MPR, P-MPR, and ΔT_{C} are defined in 3GPP TS 38.101-1, TS38.101-2 and TS 38.101-3. The remaining parameters are defined in Clause 7.1.1 of 3GPP TS 38.213 v16.4.0 where P_{O_PUSCH,b,f,c}(j) is obtained using P_{O_NOMINAL_PUSCH,f,c}(0), and α_{b,f,c}(j), PL_{b,f,c}(q_{d}), and f_{b,f,c}(i, l) are obtained using p0-PUSCH-AlphaSetId=0, pusch-PathlossReferenceRS-Id=0, and l=0, respectively, all associated with one of the two PUSCH power control sets as shown in FIG. 11. Note that, as defined in 3GPP TS 38.213 v16.4.0:
   b is a bandwidth part index;
   f is a carrier frequency index;
   c is a cell index;
   i is transmission occasion index;
   j is an index of PUSCH type;
   q_{d} is a pathloss reference RS index;
   l is a closed-loop index;
   \tilde{P}_{CMAX,f,c}(i) is a wireless communication device maximum output power for carrier frequency f of serving cell c in transmission occasion i;
   P_{O}_{_{PUSCH}}_{,b,f,c}(j) is a parameter composed of the sum of a component P_{O_NOMINAL_PUSCH,b,f,c}(j) and a component P_{O_UE_PUSCH,b,f,c}(j);
   α_{b,f,c}(j) is α_{b,f,c} is a fractional pathloss compensation factor;
   PL_{b,f,c}(q_{d}) is a pathloss estimation based on a pathloss reference signal with index q_{d};
   f_{b,f,c}(i, l) is a PUSCH power control adjustment state/for active uplink bandwidth part b of carrier f of serving cell c and PUSCH transmission occasion i.

In case of per TRP PH reporting, i.e., one PH for each TRP is reported in a PHR MAC CE, p0-PUSCH-AlphaSetId=0, pusch-PathlossReferenceRS-Id=0, and l=0 in the power control parameter set associated with the TRP for which the PH is reported. Otherwise, if one PH per activated cell is reported in a PHR, which power control parameter set for p0-PUSCH-AlphaSetId=0, pusch-PathlossReferenceRS-Id=0, and l=0 can be predefined or configured. In some embodiments, a UE may report a PH based on reference PUSCH format for one TRP and a PH based on real PUSCH transmission for another TRP.

### PHR Triggering by Pathloss Change

One of the existing PHR triggering events is when the phr-ProhibitTimer expires or has expired and the path loss has changed more than phr-Tx-PowerFactorChange dB since the last transmission of a PHR in this MAC entity when the MAC entity has UL resources for new transmission.

In case of PUSCH transmission towards multiple TRPs and per TRP PHR is reported, the pathloss change should be with respect to a same TRP, i.e., PHR is triggered when the pathloss associated with a same TRP (or an SRS resource set) has been changed by an amount that is more than phr-Tx-PowerFactorChange dB.

Therefore, the existing condition should be modified as follows:
phr-Prohibit Timer expires or has expired and the path loss has changed more than phr-Tx-PowerFactorChange dB for at least one activated Serving Cell of any MAC entity of which the active DL BWP is not dormant BWP which is used as a pathloss reference since the last transmission of a PHR in this MAC entity when the MAC entity has UL resources for new transmission, where the pathloss change is with respect to pathloss reference RS in a same PUSCH power control parameter set.

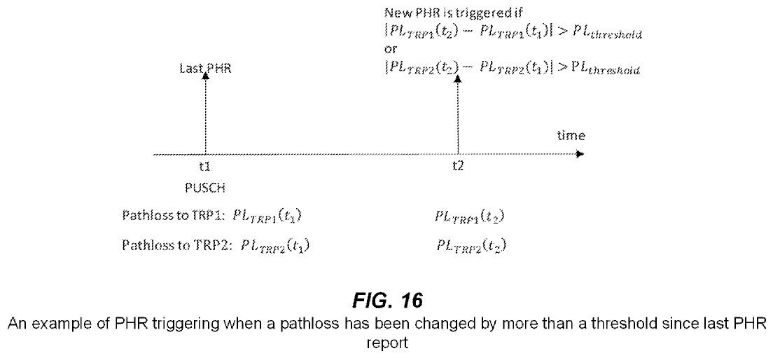

This is explained in FIG. 16 below, where if pathloss to any one of two TRPs has been changed by more than a predefined threshold, a new PHR is triggered. PL_{TRP1}(t₁) is a pathloss in dB measured at t₁ based on a pathloss reference RS in the 1^{st} set of PUSCH power control parameters in FIG. 11, and PL_{TRP2}(t₁) is a pathloss in dB measured at t₁ based on a pathloss reference RS in the 2^{nd} set of PUSCH power control parameters in FIG. 11. PL_{TRP1}(t₂) is a pathloss in dB measured at t₂ based on a same or different pathloss reference RS in the 1st set of PUSCH power control parameters, and PL_{TRP2}(t₂) is a pathloss in dB measured at t₂ based on a same or different pathloss reference RS in the 2^{nd} set of PUSCH power control parameters. PL_{threshold} is configured by phr-Tx-PowerFactorChange.

If the last PHR was sent to a single TRP, in one embodiment, only pathloss change to the single TRP is checked. In another embodiment, pathloss change to the other TRP is also checked and the change is between the pathloss measured at the present time and the pathloss measured at the first time after the last PHR report a PUSCH is sent to the other TRP.

In one embodiment, there are two timers phr-ProhibitTimer1 and phr-ProhibitTimer2 each corresponding to one TRP. These timers describe whether PHR for a given TRP can be transmitted. For example, depending on these timers UE would include in the MAC CE either one PH or two PH values and use the length field or flag to indicate whether both are present or only one of them as explained in embodiments under 6.1.1.

### New MAC CE for Carrying Multiple PHS

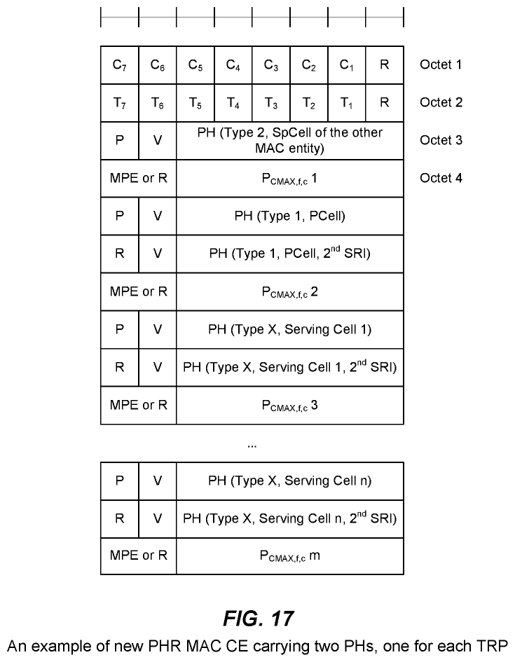

In another embodiment, every time a PHR is triggered, PHs for all TRPs in a cell are reported in a new MAC CE. An example is shown in FIG. 17, where two PHs may be reported, one for each of two TRPs, for a serving cell. If Ci=1, Ti (i=1, 2, . . . , 7) is used to indicate whether a second PH is present for the associated serving cell Cᵢ. The definition of the other fields are the same as in the existing multiple entry MAC CE.

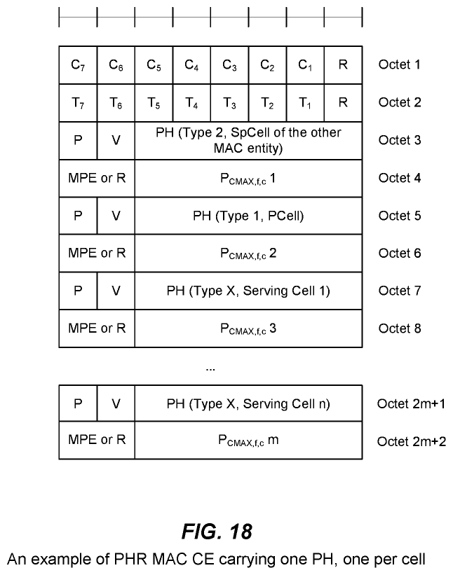

In a further embodiment, PH for only one TRP in each cell is reported in a PHR. An example of MAC CE is shown FIG. 18, where Ti (i=1, 2, . . . , 7) is used to indicate whether the PH is for 1^{st} or 2^{nd} TRP in serving cell Ci, e.g., Ti=0 indicate the 1^{st} TRP and Ti=1 indicates the 2^{nd} TRP. The definition of the other fields are the same as in existing multiple entry MAC CE.

### Further Description

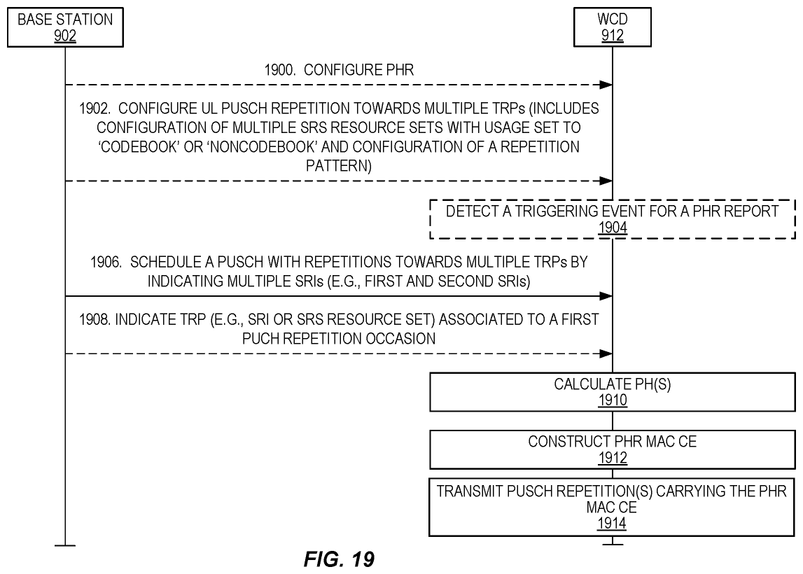

FIG. 19 illustrates the operation of a WCD 912 and a base station 902 in accordance with at least some of the embodiments described herein. Optional steps are represented by dashed lines/boxes. Note that, in one embodiment, the base station 902 is a gNB, and the WCD 912 is a UE; however, the present disclosure is not limited thereto. As illustrated in FIG. 19, the base station 902 configures a PHR for the WCD 912 (step 1900). The base station 902 also configures the WCD 912 for uplink transmission with repetitions (e.g., PUSCH with repetitions) towards multiple TRPs (step 1902). This configuration may include a configuration of two SRS resource sets with usage set to ‘Codebook’ or ‘nonCodebook’ and a repetition factor.

At the WCD 912, a PHR is triggered by a triggering event (step 1904). In one embodiment, the PHR triggering is in accordance with the embodiment described above in the section “PHR Triggering by Pathloss Change”.

The base station 902 schedules (e.g., via DCI or configuration such as, e.g., a configured grant PUSCH), for the WCD 912, an uplink transmission with repetitions towards multiple TRPs by indicating first and second SRIs (step 1906). Each repetition is associated to one of multiple SRS resource sets (e.g., one of two SRS resource sets) configured for the WCD 912. In some embodiments, the base station 902 also provides, to the WCD 912, an indication of which of the multiple TRPs is associated with the first transmission occasion (from among those for the scheduled uplink transmission with repetitions), e.g., in accordance with any of the embodiments described above in the section “gNB Indicating a TRP associated with a First PUSCH Occasion” (step 1908). Note that while step 1906 is shown as occurring after step 1904, the triggering of step 1904 may occur after step 1908.

At the WCD 912, the WCD 912 calculates a PH(s) and constructs a PHR MAC CE in accordance with any of the embodiments described above (steps 1910 and 1912). The WCD 912 transmits the PHR MAC CE in the uplink transmission (step 1914).

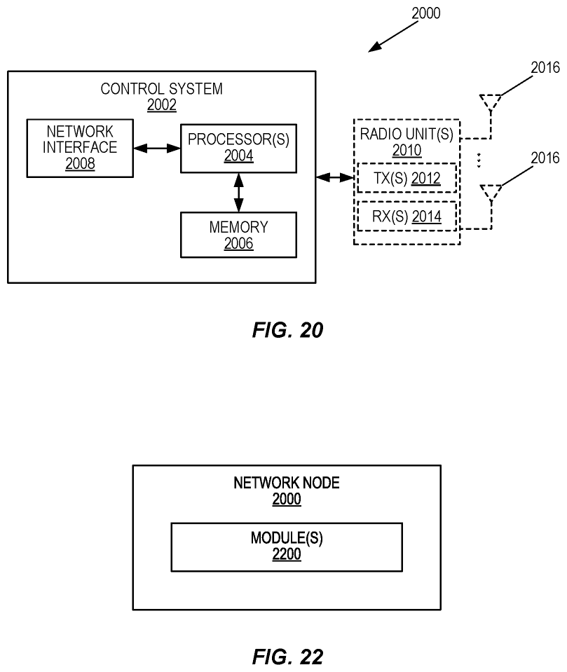

FIG. 20 is a schematic block diagram of a network node 2000 according to some embodiments of the present disclosure. Optional features are represented by dashed boxes. The network node 2000 may be, for example, a base station 902 or 906 or a network node that implements all or part of the functionality of the base station 902 or gNB described herein. As illustrated, the network node 2000 includes a control system 2002 that includes one or more processors 2004 (e.g., Central Processing Units (CPUs), Application Specific Integrated Circuits (ASICs), Field Programmable Gate Arrays (FPGAs), and/or the like), memory 2006, and a network interface 2008. The one or more processors 2004 are also referred to herein as processing circuitry. In addition, if the network node 2000 is a radio access node (e.g., a base station 902, gNB, or network node that implements at least some of the functionality of the base station 902 or gNB), the network node 2000 may include one or more radio units 2010 that each includes one or more transmitters 2012 and one or more receivers 2014 coupled to one or more antennas 2016. The radio units 2010 may be referred to or be part of radio interface circuitry. In some embodiments, the radio unit(s) 2010 is external to the control system 2002 and connected to the control system 2002 via, e.g., a wired connection (e.g., an optical cable). However, in some other embodiments, the radio unit(s) 2010 and potentially the antenna(s) 2016 are integrated together with the control system 2002. The one or more processors 2004 operate to provide one or more functions of the network node 2000 as described herein (e.g., one or more functions of a base station 902 or gNB described herein). In some embodiments, the function(s) are implemented in software that is stored, e.g., in the memory 2006 and executed by the one or more processors 2004.

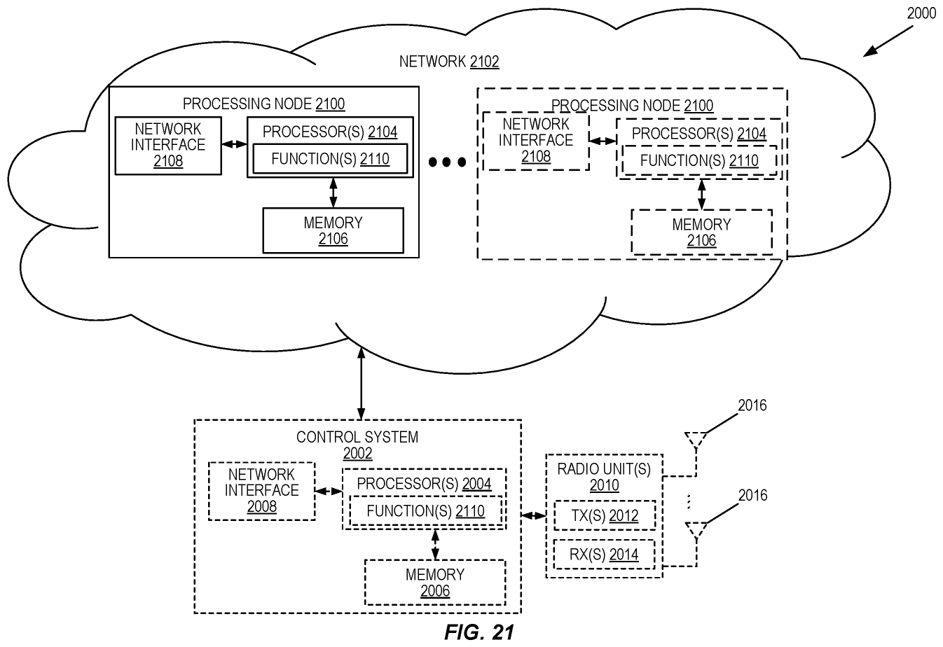

FIG. 21 is a schematic block diagram that illustrates a virtualized embodiment of the network node 2000 according to some embodiments of the present disclosure. Again, optional features are represented by dashed boxes. As used herein, a “virtualized” network node is an implementation of the network node 2000 in which at least a portion of the functionality of the network node 2000 is implemented as a virtual component(s) (e.g., via a virtual machine(s) executing on a physical processing node(s) in a network(s)). As illustrated, in this example, if the network node 2000 is a radio access node, the network node 2000 may include the control system 2002 and/or the one or more radio units 2010, as described above. The control system 2002 may be connected to the radio unit(s) 2010 via, for example, an optical cable or the like. The network node 2000 includes one or more processing nodes 2100 coupled to or included as part of a network(s) 2102. If present, the control system 2002 or the radio unit(s) are connected to the processing node(s) 2100 via the network 2102. Each processing node 2100 includes one or more processors 2104 (e.g., CPUs, ASICS, FPGAS, and/or the like), memory 2106, and a network interface 2108.

In this example, functions 2110 of the network node 2000 described herein (e.g., one or more functions of a base station 902 or gNB described herein) are implemented at the one or more processing nodes 2100 or distributed across the one or more processing nodes 2100 and the control system 2002 and/or the radio unit(s) 2010 in any desired manner. In some particular embodiments, some or all of the functions 2110 of the network node 2000 described herein are implemented as virtual components executed by one or more virtual machines implemented in a virtual environment(s) hosted by the processing node(s) 2100. As will be appreciated by one of ordinary skill in the art, additional signaling or communication between the processing node(s) 2100 and the control system 2002 is used in order to carry out at least some of the desired functions 2110. Notably, in some embodiments, the control system 2002 may not be included, in which case the radio unit(s) 2010 communicate directly with the processing node(s) 2100 via an appropriate network interface(s).

In some embodiments, a computer program including instructions which, when executed by at least one processor, causes the at least one processor to carry out the functionality of the network node 2000 or a node (e.g., a processing node 2100) implementing one or more of the functions 2110 of the network node 2000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 22 is a schematic block diagram of the network node 2000 according to some other embodiments of the present disclosure. The network node 2000 includes one or more modules 2200, each of which is implemented in software. The module(s) 2200 provide the functionality of the network node 2000 described herein. This discussion is equally applicable to the processing node 2100 of FIG. 21 where the modules 2200 may be implemented at one of the processing nodes 2100 or distributed across multiple processing nodes 2100 and/or distributed across the processing node(s) 2100 and the control system 2002.

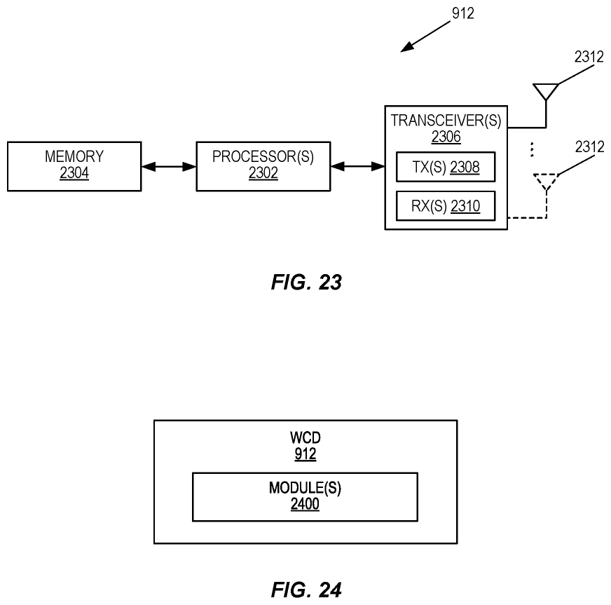

FIG. 23 is a schematic block diagram of a wireless communication device 912 (e.g., a UE) according to some embodiments of the present disclosure. As illustrated, the wireless communication device 912 includes one or more processors 2302 (e.g., CPUs, ASICS, FPGAS, and/or the like), memory 2304, and one or more transceivers 2306 each including one or more transmitters 2308 and one or more receivers 2310 coupled to one or more antennas 2312. The transceiver(s) 2306 includes radio-front end circuitry connected to the antenna(s) 2312 that is configured to condition signals communicated between the antenna(s) 2312 and the processor(s) 2302, as will be appreciated by on of ordinary skill in the art. The processors 2302 are also referred to herein as processing circuitry. The transceivers 2306 are also referred to herein as radio circuitry. In some embodiments, the functionality of the wireless communication device 912 (or UE) described above may be fully or partially implemented in software that is, e.g., stored in the memory 2304 and executed by the processor(s) 2302. Note that the wireless communication device 912 may include additional components not illustrated in FIG. 23 such as, e.g., one or more user interface components (e.g., an input/output interface including a display, buttons, a touch screen, a microphone, a speaker(s), and/or the like and/or any other components for allowing input of information into the wireless communication device 912 and/or allowing output of information from the wireless communication device 912), a power supply (e.g., a battery and associated power circuitry), etc.

In some embodiments, a computer program including instructions which, when executed by at least one processor, causes the at least one processor to carry out the functionality of the wireless communication device 912 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 24 is a schematic block diagram of the wireless communication device 912 according to some other embodiments of the present disclosure. The wireless communication device 912 includes one or more modules 2400, each of which is implemented in software. The module(s) 2400 provide the functionality of the wireless communication device 912 (or UE) described herein.

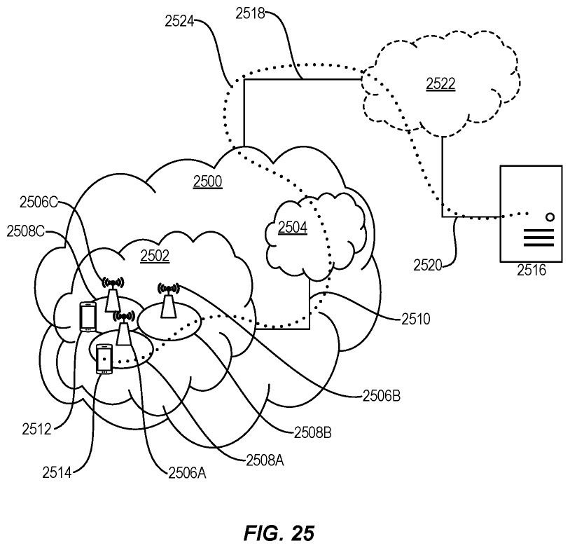

With reference to FIG. 25, in accordance with an embodiment, a communication system includes a telecommunication network 2500, such as a 3GPP-type cellular network, which comprises an access network 2502, such as a RAN, and a core network 2504. The access network 2502 comprises a plurality of base stations 2506A, 2506B, 2506C, such as Node Bs, eNBs, gNBs, or other types of wireless Access Points (APs), each defining a corresponding coverage area 2508A, 2508B, 2508C. Each base station 2506A, 2506B, 2506C is connectable to the core network 2504 over a wired or wireless connection 2510. A first UE 2512 located in coverage area 2508C is configured to wirelessly connect to, or be paged by, the corresponding base station 2506C. A second UE 2514 in coverage area 2508A is wirelessly connectable to the corresponding base station 2506A. While a plurality of UEs 2512, 2514 are illustrated in this example, the disclosed embodiments are equally applicable to a situation where a sole UE is in the coverage area or where a sole UE is connecting to the corresponding base station 2506.

The telecommunication network 2500 is itself connected to a host computer 2516, which may be embodied in the hardware and/or software of a standalone server, a cloud-implemented server, a distributed server, or as processing resources in a server farm. The host computer 2516 may be under the ownership or control of a service provider, or may be operated by the service provider or on behalf of the service provider. Connections 2518 and 2520 between the telecommunication network 2500 and the host computer 2516 may extend directly from the core network 2504 to the host computer 2516 or may go via an optional intermediate network 2522. The intermediate network 2522 may be one of, or a combination of more than one of, a public, private, or hosted network; the intermediate network 2522, if any, may be a backbone network or the Internet; in particular, the intermediate network 2522 may comprise two or more sub-networks (not shown).

The communication system of FIG. 25 as a whole enables connectivity between the connected UEs 2512, 2514 and the host computer 2516. The connectivity may be described as an Over-the-Top (OTT) connection 2524. The host computer 2516 and the connected UEs 2512, 2514 are configured to communicate data and/or signaling via the OTT connection 2524, using the access network 2502, the core network 2504, any intermediate network 2522, and possible further infrastructure (not shown) as intermediaries. The OTT connection 2524 may be transparent in the sense that the participating communication devices through which the OTT connection 2524 passes are unaware of routing of uplink and downlink communications. For example, the base station 2506 may not or need not be informed about the past routing of an incoming downlink communication with data originating from the host computer 2516 to be forwarded (e.g., handed over) to a connected UE 2512. Similarly, the base station 2506 need not be aware of the future routing of an outgoing uplink communication originating from the UE 2512 towards the host computer 2516.

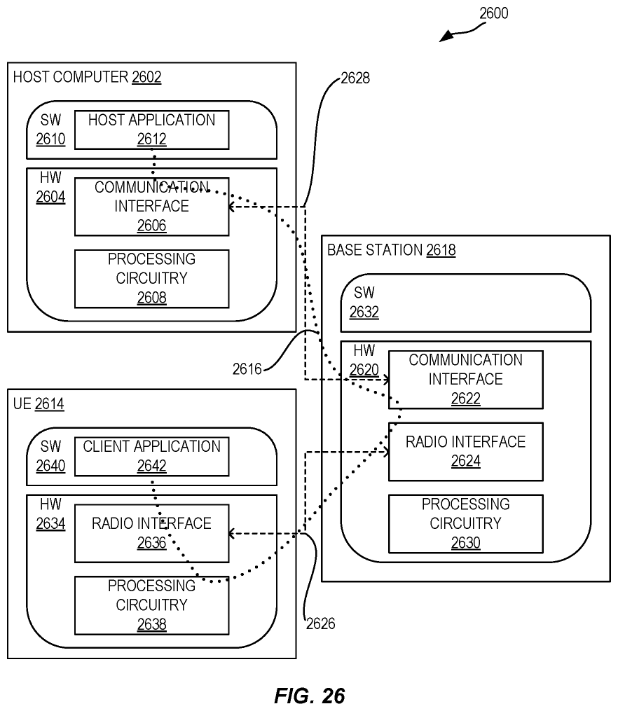

Example implementations, in accordance with an embodiment, of the UE, base station, and host computer discussed in the preceding paragraphs will now be described with reference to FIG. 26. In a communication system 2600, a host computer 2602 comprises hardware 2604 including a communication interface 2606 configured to set up and maintain a wired or wireless connection with an interface of a different communication device of the communication system 2600. The host computer 2602 further comprises processing circuitry 2608, which may have storage and/or processing capabilities. In particular, the processing circuitry 2608 may comprise one or more programmable processors, ASICS, FPGAS, or combinations of these (not shown) adapted to execute instructions. The host computer 2602 further comprises software 2610, which is stored in or accessible by the host computer 2602 and executable by the processing circuitry 2608. The software 2610 includes a host application 2612. The host application 2612 may be operable to provide a service to a remote user, such as a UE 2614 connecting via an OTT connection 2616 terminating at the UE 2614 and the host computer 2602. In providing the service to the remote user, the host application 2612 may provide user data which is transmitted using the OTT connection 2616.

The communication system 2600 further includes a base station 2618 provided in a telecommunication system and comprising hardware 2620 enabling it to communicate with the host computer 2602 and with the UE 2614. The hardware 2620 may include a communication interface 2622 for setting up and maintaining a wired or wireless connection with an interface of a different communication device of the communication system 2600, as well as a radio interface 2624 for setting up and maintaining at least a wireless connection 2626 with the UE 2614 located in a coverage area (not shown in FIG. 26) served by the base station 2618. The communication interface 2622 may be configured to facilitate a connection 2628 to the host computer 2602. The connection 2628 may be direct or it may pass through a core network (not shown in FIG. 26) of the telecommunication system and/or through one or more intermediate networks outside the telecommunication system. In the embodiment shown, the hardware 2620 of the base station 2618 further includes processing circuitry 2630, which may comprise one or more programmable processors, ASICs, FPGAS, or combinations of these (not shown) adapted to execute instructions. The base station 2618 further has software 2632 stored internally or accessible via an external connection.

The communication system 2600 further includes the UE 2614 already referred to. The UE's 2614 hardware 2634 may include a radio interface 2636 configured to set up and maintain a wireless connection 2626 with a base station serving a coverage area in which the UE 2614 is currently located. The hardware 2634 of the UE 2614 further includes processing circuitry 2638, which may comprise one or more programmable processors, ASICs, FPGAS, or combinations of these (not shown) adapted to execute instructions. The UE 2614 further comprises software 2640, which is stored in or accessible by the UE 2614 and executable by the processing circuitry 2638. The software 2640 includes a client application 2642. The client application 2642 may be operable to provide a service to a human or non-human user via the UE 2614, with the support of the host computer 2602. In the host computer 2602, the executing host application 2612 may communicate with the executing client application 2642 via the OTT connection 2616 terminating at the UE 2614 and the host computer 2602. In providing the service to the user, the client application 2642 may receive request data from the host application 2612 and provide user data in response to the request data. The OTT connection 2616 may transfer both the request data and the user data. The client application 2642 may interact with the user to generate the user data that it provides.

It is noted that the host computer 2602, the base station 2618, and the UE 2614 illustrated in FIG. 26 may be similar or identical to the host computer 2516, one of the base stations 2506A, 2506B, 2506C, and one of the UEs 2512, 2514 of FIG. 25, respectively. This is to say, the inner workings of these entities may be as shown in FIG. 26 and independently, the surrounding network topology may be that of FIG. 25.

In FIG. 26, the OTT connection 2616 has been drawn abstractly to illustrate the communication between the host computer 2602 and the UE 2614 via the base station 2618 without explicit reference to any intermediary devices and the precise routing of messages via these devices. The network infrastructure may determine the routing, which may be configured to hide from the UE 2614 or from the service provider operating the host computer 2602, or both. While the OTT connection 2616 is active, the network infrastructure may further take decisions by which it dynamically changes the routing (e.g., on the basis of load balancing consideration or reconfiguration of the network).

The wireless connection 2626 between the UE 2614 and the base station 2618 is in accordance with the teachings of the embodiments described throughout this disclosure. One or more of the various embodiments improve the performance of OTT services provided to the UE 2614 using the OTT connection 2616, in which the wireless connection 2626 forms the last segment.

A measurement procedure may be provided for the purpose of monitoring data rate, latency, and other factors on which the one or more embodiments improve. There may further be an optional network functionality for reconfiguring the OTT connection 2616 between the host computer 2602 and the UE 2614, in response to variations in the measurement results. The measurement procedure and/or the network functionality for reconfiguring the OTT connection 2616 may be implemented in the software 2610 and the hardware 2604 of the host computer 2602 or in the software 2640 and the hardware 2634 of the UE 2614, or both. In some embodiments, sensors (not shown) may be deployed in or in association with communication devices through which the OTT connection 2616 passes; the sensors may participate in the measurement procedure by supplying values of the monitored quantities exemplified above, or supplying values of other physical quantities from which the software 2610, 2640 may compute or estimate the monitored quantities. The reconfiguring of the OTT connection 2616 may include message format, retransmission settings, preferred routing, etc.; the reconfiguring need not affect the base station 2618, and it may be unknown or imperceptible to the base station 2618. Such procedures and functionalities may be known and practiced in the art. In certain embodiments, measurements may involve proprietary UE signaling facilitating the host computer 2602's measurements of throughput, propagation times, latency, and the like. The measurements may be implemented in that the software 2610 and 2640 causes messages to be transmitted, in particular empty or ‘dummy’ messages, using the OTT connection 2616 while it monitors propagation times, errors, etc.

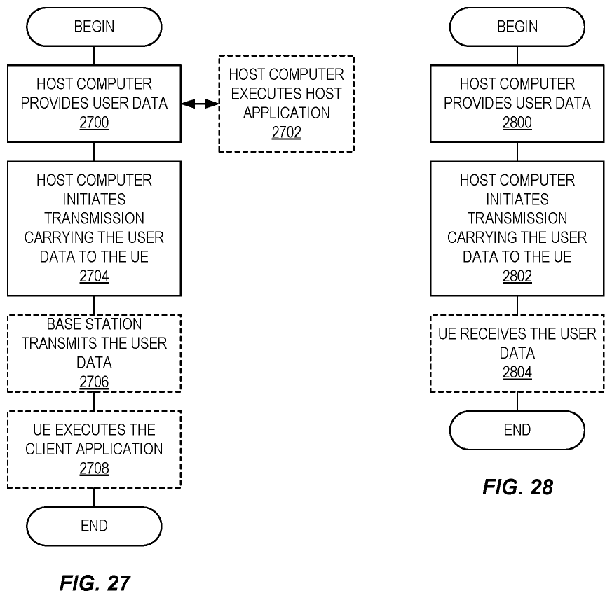

FIG. 27 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 27 will be included in this section. In step 2700, the host computer provides user data. In sub-step 2702 (which may be optional) of step 2700, the host computer provides the user data by executing a host application. In step 2704, the host computer initiates a transmission carrying the user data to the UE. In step 2706 (which may be optional), the base station transmits to the UE the user data which was carried in the transmission that the host computer initiated, in accordance with the teachings of the embodiments described throughout this disclosure. In step 2708 (which may also be optional), the UE executes a client application associated with the host application executed by the host computer.

FIG. 28 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 28 will be included in this section. In step 2800 of the method, the host computer provides user data. In an optional sub-step (not shown) the host computer provides the user data by executing a host application. In step 2802, the host computer initiates a transmission carrying the user data to the UE. The transmission may pass via the base station, in accordance with the teachings of the embodiments described throughout this disclosure. In step 2804 (which may be optional), the UE receives the user data carried in the transmission.

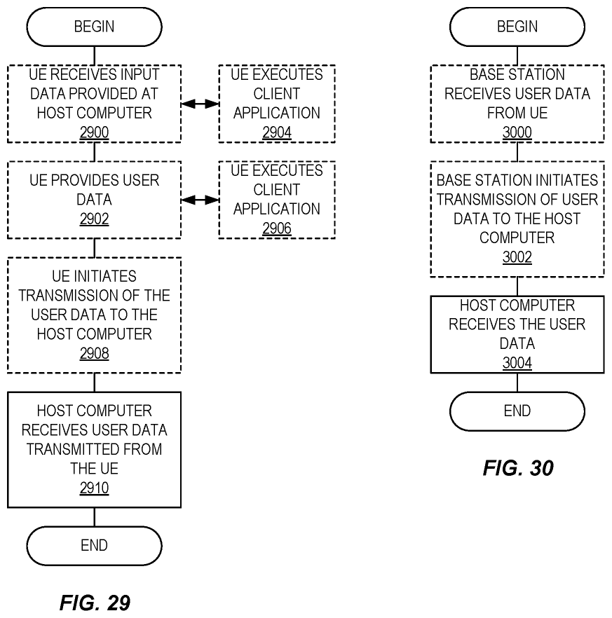

FIG. 29 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 29 will be included in this section. In step 2900 (which may be optional), the UE receives input data provided by the host computer. Additionally or alternatively, in step 2902, the UE provides user data. In sub-step 2904 (which may be optional) of step 2900, the UE provides the user data by executing a client application. In sub-step 2906 (which may be optional) of step 2902, the UE executes a client application which provides the user data in reaction to the received input data provided by the host computer. In providing the user data, the executed client application may further consider user input received from the user. Regardless of the specific manner in which the user data was provided, the UE initiates, in sub-step 2908 (which may be optional), transmission of the user data to the host computer. In step 2910 of the method, the host computer receives the user data transmitted from the UE, in accordance with the teachings of the embodiments described throughout this disclosure.

FIG. 30 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 30 will be included in this section. In step 3000 (which may be optional), in accordance with the teachings of the embodiments described throughout this disclosure, the base station receives user data from the UE. In step 3002 (which may be optional), the base station initiates transmission of the received user data to the host computer. In step 3004 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless communication device (912), the method comprising one of more of:
receiving (1906), from a base station (902), downlink control information or a configuration (e.g., for configured grant PUSCH) that schedules an uplink transmission with two or more repetitions, wherein each of the two or more repetitions is associated to one of two or more Sounding Reference Signal, SRS, resource sets, and a power headroom report, PHR, is triggered and is to be carried by the uplink transmission;
calculating (1910) at least one power headroom, PH, value associated to at least one of the two or more SRS resource sets;
constructing (1912) a PHR Medium Access Control, MAC, Control Element, CE, comprising the at least one PH value; and
transmitting (1914) the PHR MAC CE in the uplink transmission.

Embodiment 2: The method of embodiment 1 wherein the uplink transmission is a Physical Uplink Shared Chanel, PUSCH, transmission.

Embodiment 3: The method of embodiment 1 or 2 wherein the PHR MAC CE comprises information that indicates the at least one of the two or more SRS resource sets associated to the at least one PH value comprised in the PHR MAC CE.

Embodiment 4: The method of embodiment 1 or 2 wherein the at least one PH value is a PH value associated to one of the two or more resource sets, and the PHR MAC CE comprises information that indicates the one of the two or more resource sets associated to the PH value comprised in the PHR MAC CE.

Embodiment 5: The method of embodiment 1 or 2 wherein:
the two or more repetitions consist of a first repetition associated to a first SRS resource set and a second repetition associated to a second SRS resource set; and/or
the at least one PH value is either: (a) a PH value associated to one of the first and second SRS resource sets or (b) both a first PH value associated to the first SRS resource set and a second PH value associated to the second SRS resource set; and/or
the PHR MAC CE comprises information that indicates whether the PHR MAC CE comprises: (a) a PH value associated to one of the first and second SRS resource sets or (b) both a first PH value associated to the first SRS resource set and a second PH value associated to the second SRS resource set.

Embodiment 6: The method of embodiment 1 or 2 wherein each PH value of the at least one PH value is calculated based on a first transmission occasion from among those scheduled for the two or more repetitions.

Embodiment 7: The method of embodiment 6 further comprising receiving (1908), from the base station (902), information that indicates which SRS resource set from among the two or more SRS resource sets is associated to the first transmission occasion.

Embodiment 8: The method of embodiment 7 wherein the at least one PH value comprised in the PHR MAC CE is a PH value associated to the SRS resource set associated to the first transmission occasion.

Embodiment 9: The method of embodiment 7 or 8 wherein different SRS resource sets are indicated as being associated to first transmission occasions for different scheduled uplink transmissions.

Embodiment 10: The method of any of embodiments 7 to 9 wherein the information that indicates which SRS resource set from among the two or more SRS resource sets is associated to the first transmission occasion is comprised in the downlink control information.

Embodiment 11: The method of embodiment 10 wherein a single bitfield in the downlink control information is used to jointly encode whether the two or more repetitions are associated to a single SRS resource set or multiple SRS resource sets among the two or more SRS resource sets and the SRS resource set from among the two or more SRS resource sets is associated to the first transmission occasion.

Embodiment 12: The method of embodiment 6 wherein the SRS resource set from among the two or more SRS resource sets that is associated with the first transmission occasion is changed (e.g., toggled) in different periods.

Embodiment 13: The method of any of embodiments 1 to 12 wherein separate power control parameters are associated to the two or more SRS resource sets, and calculating (1910) the at least one PH value comprises, for transmission occasion i on active uplink bandwidth part b of carrier f of serving cell c, calculating (1910) a PH value as:

$${PH}_{type 1 , b , f , c} ( i , j , {q}_{d} , l ) = {\tilde{P}}_{CMAX , f , c} ( i ) - \{ {P}_{O\_PUSCH , b , f , c} ( j ) + {α}_{b , f , c} ( j ) \cdot {PL}_{b , f , c} ( {q}_{d} ) + {f}_{b , f , c} ( i , l ) \} [ dB ]$$

Embodiment 14: The method of any of embodiments 1 to 13 further comprising detecting (1904) a triggering event for a PHR.

Embodiment 15: The method of embodiment 14 wherein the triggering event is when a timer has expired and a pathloss has changed more than a threshold amount since a last transmission of a PHR, wherein the pathloss change is with respect to a pathloss reference signal in a same uplink (e.g., PUSCH) power control parameter set.

Embodiment 16: The method of embodiment 14 wherein the triggering event is when a timer has expired and a pathloss associated to a same SRS resource set has changed more than a threshold amount since a last transmission of a PHR.

Embodiment 17: The method of embodiment 15 or 16 wherein different timers are associated to different SRS resource sets.

Embodiment 18: The method of any of embodiments 1 to 17 wherein the PHR MAC CE is in accordance with a defined PHR MAC CE format that can carry multiple PH values.

Embodiment 19: The method of any of the previous embodiments, further comprising: providing user data; and forwarding the user data to a host computer via the transmission to the base station.

### Group B Embodiments

Embodiment 20: A method performed by a base station comprising:
transmitting (1906), to a wireless communication device (912), downlink control information or a configuration that schedules an uplink transmission with two or more repetitions, wherein each of the two or more repetitions is associated to one of two or more Sounding Reference Signal, SRS, resource sets; and/or
receiving from the wireless communication device (912) a power headroom report, PHR, carried over the uplink transmission.

Embodiment 21: The method of embodiment 20 wherein the PHR is carried in a PHR Medium Access Control, MAC, Control Element, CE, and comprises information that indicates the at least one of the two or more SRS resource sets associated to at least one PH value comprised in the PHR MAC CE.

Embodiment 22: The methods of embodiments 20 or 21 wherein the PHR MAC CE used to provide the PHR comprises:
a PH value associated to one of the two or more SRS resource sets; and/or
information that indicates the one of the two or more SRS resource sets associated to the PH value comprised in the PHR MAC CE.

Embodiment 23: The methods of embodiments 20 or 21 wherein:
the two or more repetitions consist of a first repetition associated to a first SRS resource set and a second repetition associated to a second SRS resource set; and/or
the PHR MAC CE used to provide the PHR comprises at least one PH value, the at least one PH value being either: (a) a PH value associated to one of the first and second SRS resource sets or (b) both a first PH value associated to the first SRS resource set and a second PH value associated to the second SRS resource set; and/or
the PHR MAC CE comprises information that indicates whether the PHR MAC CE comprises: (a) a PH value associated to one of the first and second SRS resource sets or (b) both a first PH value associated to the first SRS resource set and a second PH value associated to the second SRS resource set.

Embodiment 24: The methods of embodiments 20 or 21 wherein the PHR MAC CE used to provide the PHR comprises at least one PH value, and each PH value of the at least one PH value is calculated based on a first transmission occasion from among those scheduled for the two or more repetitions.

Embodiment 25: The method of embodiment 24 further comprising transmitting (1908), to the wireless communication device (912), information that indicates which SRS resource set from among the two or more SRS resource sets is associated to the first transmission occasion.

Embodiment 26: The method of embodiment 25 wherein the at least one PH value comprised in the PHR MAC CE is a PH value associated to the SRS resource set associated to the first PUSCH transmission occasion.

Embodiment 27: The method of embodiment 25 or 26 wherein different SRS resource sets are indicated as being associated to first transmission occasions for different scheduled uplink transmissions.

Embodiment 28: The method of any of embodiments 25 to 27 wherein the information that indicates which SRS resource set from among the two or more SRS resource sets is associated to the first transmission occasion is comprised in the downlink control information.

Embodiment 29: The method of embodiment 28 wherein a single bitfield in the downlink control information is used to jointly encode whether the two or more repetitions are associated to a single SRS resource set or multiple SRS resource sets among the two or more SRS resource sets and the SRS resource set from among the two or more SRS resource sets is associated to the first transmission occasion.

Embodiment 30: The method of any of embodiments 20 to 29 wherein the PHR MAC CE used to provide the PHR comprises two or more PH values, and the PHR MAC CE is in accordance with a defined PHR MAC CE format that can carry multiple PH values.

Embodiment 31: The method of any of the previous embodiments, further comprising: obtaining user data; and forwarding the user data to a host computer or a wireless communication device.

### Group C Embodiments

Embodiment 32: A wireless communication device comprising:
processing circuitry configured to perform any of the steps of any of the Group A embodiments; and
power supply circuitry configured to supply power to the wireless communication device.

Embodiment 33: A base station comprising:
processing circuitry configured to perform any of the steps of any of the Group B embodiments; and
power supply circuitry configured to supply power to the base station.

Embodiment 34: A User Equipment, UE, comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Embodiment 35: A communication system including a host computer comprising:
processing circuitry configured to provide user data; and
a communication interface configured to forward the user data to a cellular network for transmission to a User Equipment, UE;
wherein the cellular network comprises a base station having a radio interface and processing circuitry, the base station's processing circuitry configured to perform any of the steps of any of the Group B embodiments.

Embodiment 36: The communication system of the previous embodiment further including the base station.

Embodiment 37: The communication system of the previous 2 embodiments, further including the UE, wherein the UE is configured to communicate with the base station.

Embodiment 38: The communication system of the previous 3 embodiments, wherein:
the processing circuitry of the host computer is configured to execute a host application, thereby providing the user data; and
the UE comprises processing circuitry configured to execute a client application associated with the host application.

Embodiment 39: A method implemented in a communication system including a host computer, a base station, and a User Equipment, UE, the method comprising:
at the host computer, providing user data; and
at the host computer, initiating a transmission carrying the user data to the UE via a cellular network comprising the base station, wherein the base station performs any of the steps of any of the Group B embodiments.

Embodiment 40: The method of the previous embodiment, further comprising, at the base station, transmitting the user data.

Embodiment 41: The method of the previous 2 embodiments, wherein the user data is provided at the host computer by executing a host application, the method further comprising, at the UE, executing a client application associated with the host application.

Embodiment 42: A User Equipment, UE, configured to communicate with a base station, the UE comprising a radio interface and processing circuitry configured to perform the method of the previous 3 embodiments.

Embodiment 43: A communication system including a host computer comprising:
processing circuitry configured to provide user data; and
a communication interface configured to forward user data to a cellular network for transmission to a User Equipment, UE;
wherein the UE comprises a radio interface and processing circuitry, the UE's components configured to perform any of the steps of any of the Group A embodiments.

Embodiment 44: The communication system of the previous embodiment, wherein the cellular network further includes a base station configured to communicate with the UE.

Embodiment 45: The communication system of the previous 2 embodiments, wherein:
the processing circuitry of the host computer is configured to execute a host application, thereby providing the user data; and
the UE's processing circuitry is configured to execute a client application associated with the host application.

Embodiment 46: A method implemented in a communication system including a host computer, a base station, and a User Equipment, UE, the method comprising:
at the host computer, providing user data; and
at the host computer, initiating a transmission carrying the user data to the UE via a cellular network comprising the base station, wherein the UE performs any of the steps of any of the Group A embodiments.

Embodiment 47: The method of the previous embodiment, further comprising at the UE, receiving the user data from the base station.

Embodiment 48: A communication system including a host computer comprising:
communication interface configured to receive user data originating from a transmission from a User Equipment, UE, to a base station;
wherein the UE comprises a radio interface and processing circuitry, the UE's processing circuitry configured to perform any of the steps of any of the Group A embodiments.

Embodiment 49: The communication system of the previous embodiment, further including the UE.

Embodiment 50: The communication system of the previous 2 embodiments, further including the base station, wherein the base station comprises a radio interface configured to communicate with the UE and a communication interface configured to forward to the host computer the user data carried by a transmission from the UE to the base station.

Embodiment 51: The communication system of the previous 3 embodiments, wherein:
the processing circuitry of the host computer is configured to execute a host application; and
the UE's processing circuitry is configured to execute a client application associated with the host application, thereby providing the user data.

Embodiment 52: The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

Embodiment 53: A method implemented in a communication system including a host computer, a base station, and a User Equipment, UE, the method comprising, at the host computer, receiving user data transmitted to the base station from the UE, wherein the UE performs any of the steps of any of the Group A embodiments.

Embodiment 54: The method of the previous embodiment, further comprising, at the UE, providing the user data to the base station.

Embodiment 55: The method of the previous 2 embodiments, further comprising:
at the UE, executing a client application, thereby providing the user data to be transmitted; and
at the host computer, executing a host application associated with the client application.

Embodiment 56: The method of the previous 3 embodiments, further comprising:
at the UE, executing a client application; and
at the UE, receiving input data to the client application, the input data being provided at the host computer by executing a host application associated with the client application;
wherein the user data to be transmitted is provided by the client application in response to the input data.

Embodiment 57: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 58: The communication system of the previous embodiment further including the base station.

Embodiment 59: The communication system of the previous 2 embodiments, further including the UE, wherein the UE is configured to communicate with the base station.

Embodiment 60: The communication system of the previous 3 embodiments, wherein:
the processing circuitry of the host computer is configured to execute a host application; and
the UE is configured to execute a client application associated with the host application, thereby providing the user data to be received by the host computer.

Embodiment 61: A method implemented in a communication system including a host computer, a base station, and a User Equipment, UE, the method comprising, at the host computer, receiving, from the base station, user data originating from a transmission which the base station has received from the UE, wherein the UE performs any of the steps of any of the Group A embodiments.

Embodiment 62: The method of the previous embodiment, further comprising at the base station, receiving the user data from the UE.

Embodiment 63: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a wireless communication device, the method comprising:
receiving, from a base station, downlink control information or a configuration that schedules an uplink transmission with two or more repetitions, wherein each of the two or more repetitions is associated to a different one of two or more Sounding Reference Signal, SRS, resource sets and a different one of two or more power headrooms, PHs, and a power headroom report, PHR, is triggered and is to be carried by the uplink transmission;
calculating from among the two or more PHs, either a first PH associated with a first SRS resource set or a second PH associated with a second SRS resource set;
receiving an indication from the base station about a corresponding SRS resource set that is associated with a first repetition of the two or more repetitions;
constructing a PHR Medium Access Control, MAC, Control Element, CE, comprising either the first PH or the second PH based on the indication; and
transmitting the PHR MAC CE in the uplink transmission.

2. The method of claim 1 wherein the uplink transmission is a Physical Uplink Shared Chanel, PUSCH, transmission.

3. The method of claim 1 wherein either the first PH or the second PH is calculated based on a first transmission occasion in time from among those scheduled for the two or more repetitions.

4. The method of claim 3 further comprising:
receiving, from the base station, information that indicates which SRS resource set from among the two or more SRS resource sets is associated to the first transmission occasion.

5. The method of claim 4 wherein either the first PH or the second PH comprised in the PHR MAC CE is a PH associated to the SRS resource set associated to the first transmission occasion.

6. The method of claim 4 wherein different SRS resource sets may be indicated as being associated to first transmission occasions for different scheduled uplink transmissions.

7. The method of claim 4 wherein the information that indicates which SRS resource set from among the two or more SRS resource sets is associated to the first transmission occasion is comprised in the downlink control information.

8. The method of claim 7 wherein a single bitfield in the downlink control information is used to jointly encode whether the two or more repetitions are associated to a single SRS resource set or multiple SRS resource sets among the two or more SRS resource sets and which SRS resource set from among the two or more SRS resource sets is associated to the first transmission occasion.

9. The method of claim 3 wherein the SRS resource set from among the two or more SRS resource sets that is associated with the first transmission occasion can be changed in different time periods.

10. The method of claim 1 wherein the PHR MAC CE comprises information that indicates one of the two or more SRS resource sets associated to each of either the first PH or the second PH comprised in the PHR MAC CE.

11. The method of claim 1 wherein either the first PH or the second PH is a PH associated to one of the two or more SRS resource sets, and the PHR MAC CE comprises information that indicates the one of the two or more SRS resource sets associated to the PH comprised in the PHR MAC CE.

12. The method of claim 1 wherein:
(a) the two or more repetitions consist of a first repetition associated to a first SRS resource set and a second repetition associated to a second SRS resource set;
(b) the at least one PH value is either: (i) a PH value associated to one of the first and second SRS resource sets or (ii) both a first PH value associated to the first SRS resource set and a second PH value associated to the second SRS resource set;
(c) the PHR MAC CE comprises information that indicates whether the PHR MAC CE comprises: (i) a PH value associated to one of the first and second SRS resource sets or (ii) both a first PH value associated to the first SRS resource set and a second PH value associated to the second SRS resource set; or
(d) any combination of two or more of (a)-(c).

13. The method of claim 1 wherein separate power control parameters are associated to the two or more SRS resource sets, and calculating the at least one PH value comprises, for transmission occasion i on active uplink bandwidth part b of carrier f of serving cell c, calculating a PH value as:
$${PH}_{type 1 , b , f , c} ( i , j , {q}_{d} , l ) = {\tilde{P}}_{CMAX , f , c} ( i ) - \{ {P}_{O\_PUSCH , b , f , c} ( j ) + {α}_{b , f , c} ( j ) \cdot {PL}_{b , f , c} ( {q}_{d} ) + {f}_{b , f , c} ( i , l ) \} [ dB ]$$
where:
b is a bandwidth part index;
f is a carrier frequency index;
c is a cell index;
i is transmission occasion index;
j is an index of PUSCH type;
q_{d} is a pathloss reference RS index;
l is a closed-loop index;
\tilde{P}_{CMAX,f,c}(i) is a wireless communication device maximum output power for carrier frequency f of serving cell c in transmission occasion i;
P_{O}_{_{PUSCH}}_{,b,f,c}(j) is a parameter composed of the sum of a component
P_{O_NOMINAL_PUSCH,b,f,c}(j) and a component P_{O_UE_PUSCH,b,f,c}(j);
α_{b,f,c}(j) is α_{b,f,c} is a fractional pathloss compensation factor;
PL_{b,f,c}(q_{d}) is a pathloss estimation based on a pathloss reference signal with index q_{d};
f_{b,f,c}(i, l) is a PUSCH power control adjustment state l for active uplink bandwidth part b of carrier f of serving cell c and PUSCH transmission occasion i.

14. The method of claim 1 further comprising detecting a triggering event for a PHR.

15. The method of claim 14 wherein the triggering event is when a PHR timer has expired and a pathloss has changed more than a threshold amount since a last transmission of a PHR, wherein the pathloss change is with respect to any pathloss reference signal among one or multiple pathloss reference signals configured in a same uplink power control parameter set associated with one of the two or more SRS resource sets.

16. The method of claim 14 wherein the triggering event is when a timer has expired and a pathloss associated to any one of the two or more SRS resource sets has changed more than a threshold amount since a last transmission of a PHR.

17. The method of claim 15 wherein different timers are associated to different SRS resource sets.

18. The method of claim 1 wherein the PHR MAC CE is in accordance with a defined PHR MAC CE format that can carry multiple PHs.

19. (canceled)

20. (canceled)

21. A wireless communication device comprising:
one or more transmitters;
one or more receivers; and
processing circuitry associated with the one or more transmitters and the one or more receivers, the processing circuitry configured to cause the wireless communication device to:
receive, from a base station, downlink control information or a configuration that schedules an uplink transmission with two or more repetitions, wherein each of the two or more repetitions is associated to a different one of two or more Sounding Reference Signal, SRS, resource sets and a different one of two or more power headrooms, PHs, and a power headroom report, PHR, is triggered and is to be carried by the uplink transmission;
calculate from among the two or more PHs, either a first PH associated with a first SRS resource set or a second PH associated with a second SRS resource set;
receive an indication from the base station about a corresponding SRS resource set that is associated with a first repetition of the two or more repetitions;
construct a PHR Medium Access Control, MAC, Control Element, CE, either the first PH or the second PH based on the indication; and
transmit the PHR MAC CE in the uplink transmission.

22. (canceled)

23. A method performed by a base station, the method comprising:
transmitting, to a wireless communication device, downlink control information or a configuration that schedules an uplink transmission with two or more repetitions, wherein each of the two or more repetitions is associated to one of two or more Sounding Reference Signal, SRS, resource sets and a different one of two or more power headrooms, PHs;
transmitting to the wireless communication device an indication about a corresponding SRS resource set that is associated with a first repetition of the two or more repetitions; and
receiving from the wireless communication device a power headroom report, PHR, carried over the uplink transmission, the PHR comprising at least one PH among the two or more PHs.

24. The method of claim 23 wherein the PHR is carried in a PHR Medium Access Control, MAC, Control Element, CE, and comprises either a first PH associated with a first SRS resource set or a second PH associated with a second SRS resource set based on the indication.

25. The methods of claim 23 wherein the PHR MAC CE used to provide the PHR comprises at least one PH, and the at least one PH is calculated based on a first transmission occasion in time from among those scheduled for the two or more repetitions.

26. The method of claim 25 further comprising:
transmitting, to the wireless communication device, information that indicates which SRS resource set from among the two or more SRS resource sets is associated to the first transmission occasion.

27. The method of claim 26 wherein the at least one PH comprised in the PHR MAC CE is a PH associated to the SRS resource set associated to the first PUSCH transmission occasion.

28. The method of claim 26 wherein different SRS resource sets may be indicated as being associated to first transmission occasions for different scheduled uplink transmissions.

29-35. (canceled)

36. A base station comprising processing circuitry configured to cause the base station to:
transmit, to a wireless communication device, downlink control information or a configuration that schedules an uplink transmission with two or more repetitions, wherein each of the two or more repetitions is associated to one of two or more Sounding Reference Signal, SRS, resource sets and a different one of two or more power headrooms, PHs;
transmit to the wireless communication device an indication about a corresponding SRS resource set that is associated with a first repetition of the two or more repetitions; and
receive from the wireless communication device a power headroom report, PHR, carried over the uplink transmission, the PHR comprising at least one PH among the two or more PHs.

37. (canceled)
